(19) United States
(12) Patent Application Publication
(10) Pub. No.: US 2025/0256341 A1
(43) Pub. Date: Aug. 14, 2025

(54) VISE AND RECIPROCATING SAW

(71) Applicant: MAKITA CORPORATION, Anjo-shi (JP)

(72) Inventors: Tomohiro Ukai, Anjo-shi (JP); Yuta Yamashita, Anjo-shi (JP)

(73) Assignee: MAKITA CORPORATION, Anjo-shi (JP)

(21) Appl. No.: 19/013,199

(22) Filed: Jan. 8, 2025

(30) Foreign Application Priority Data
Feb. 9, 2024 (JP) 2024-018452
Feb. 9, 2024 (JP) 2024-018498

(51) Int. Cl. B23D 55/04; B23D 55/06

(52) U.S. Cl. CPC B23D 55/04; B23D 55/06

(57) ABSTRACT

A vise to be attached to a reciprocating saw includes a chain, a vise base, a tightening tool, and an elastic member. The chain includes a pin and is to be wound around a work material. The vise base is to be brought into contact with the work material and includes an insertion space into which the pin is inserted and a recess provided in the insertion space and in which the pin is hooked. The tightening tool is to be operated to pull the chain wound around the work material and is coupled to the chain. The elastic member prevents the pin hooked in the recess from dropping.

### CROSS-REFERENCE TO RELATED APPLICATION(S)

The present application claims priority to and incorporates by reference the entire contents of Japanese Patent Applications No. 2024-018498 and No. 2024-018452 both filed in Japan on Feb. 9, 2024.

### TECHNICAL FIELD

The techniques disclosed herein relates to a vise and a reciprocating saw.

### BACKGROUD ART

In the technical field related to a reciprocating saw, a reciprocating saw to which a vise is attached as disclosed in JP H3-19623 U is known.

In the technical field related to a reciprocating saw, a reciprocating saw including a shoe attached to a front end portion of a housing as disclosed in JP H3-19623 U is known.

When the vise is fixed to a work material such as a steel pipe, an operator brings a vise base into contact with the work material, winds a chain around the work material, and then hooks a pin of the chain in a recess provided in the vise base. After hooking the pin of the chain in the recess of the vise base, the operator turns a lever. When the lever is turned, the chain is pulled and the work material is tightened by the chain. The work material is tightened by the chain, whereby the vise is fixed to the work material. After the pin of the chain is hooked in the recess of the vise base, the chain is likely to drop from the vise base. When the chain is easily drops from the vise base, the workability at the time of fixing the vise to the work material is deteriorated.

When a component disposed on the inner side of the housing is replaced, the shoe is detached from the front end portion of the housing. When the shoe is detached from the front end portion of the housing, an opening provided in the front surface of the housing is exposed. The component is removed through the opening provided in the front surface of the housing. A technique for exposing the opening with good workability is desired.

### SUMMARY

One non-limiting object of the present teachings is to suppress deterioration in workability at the time when a vise including a chain is fixed to a work material.

One non-limiting object of the present teachings is to expose an opening provided in a front surface of a housing with good workability.

In one aspect of the present teachings, a vise to be attached to a reciprocating saw may include: a chain including a pin and to be wound around a work material; a vise base to be brought into contact with the work material and including an insertion space into which the pin is inserted and a recess provided in the insertion space and in which the pin is hooked; a tightening tool to be operated to pull the chain wound around the work material, the tightening tool being coupled to the chain; and an elastic member that prevents the pin hooked in the recess from dropping.

In one aspect of the present teachings, a reciprocating saw may include: a motor; a slider that is disposed forward of the motor and to which a blade is fixed; a reciprocating motion conversion mechanism that reciprocates the slider in a front-rear direction owing to a rotational force of the motor; a housing that houses the slider; and a shoe having a blade opening in which the blade is disposed, the shoe being attached to the housing to cover an opening provided in a front surface of the housing. The shoe may be configured to retract from the front surface of the housing in a state of being attached to the housing, so that the opening is exposed.

According to the present teachings, deterioration in workability at the time when the vise including the chain is fixed to the work material is suppressed.

According to the present teachings, the opening provided in the front surface of the housing can be exposed with good workability.

### BRIEF DESCRIPTION OF THE DRAWINGS

FIG. 1 is a perspective view from the front side illustrating a reciprocating saw according to a first embodiment;

FIG. 2 is a perspective view from the rear side illustrating the reciprocating saw according to the first embodiment;

FIG. 3 is a view of the reciprocating saw according to the first embodiment viewed from the upper side;

FIG. 4 is a view of the reciprocating saw according to the first embodiment viewed from the lower side;

FIG. 5 is a view of the reciprocating saw according to the first embodiment viewed from the right side;

FIG. 6 is a cross-sectional view illustrating the reciprocating saw according to the first embodiment;

FIG. 7 is an exploded perspective view from the rear side illustrating the reciprocating saw according to the first embodiment;

FIG. 8 is a perspective view from the front side illustrating a vise according to the first embodiment;

FIG. 9 is a perspective view from the rear side illustrating the vise according to the first embodiment;

FIG. 10 is a view of the vise according to the first embodiment viewed from the right side;

FIG. 11 is a cross-sectional view illustrating the vise according to the first embodiment;

FIG. 12 is a cross-sectional view illustrating a part of the vise according to the first embodiment;

FIG. 13 is a perspective view from the rear side illustrating a part of the vise according to the first embodiment;

FIG. 14 is a perspective view from the rear side illustrating a part of a chain before being attached to a vise base according to the first embodiment;

FIG. 15 is an exploded perspective view from the rear side illustrating a part of the vise according to the first embodiment;

FIG. 16 is a view of a part of the vise according to the first embodiment viewed from the upper side;

FIG. 17 is a perspective view from the rear side illustrating an elastic member according to the first embodiment;

FIG. 18 is a view of a part of the chain immediately before being inserted into an insertion space according to the first embodiment viewed from the right side;

FIG. 19 is a perspective view illustrating a front part of a reciprocating saw according to an embodiment;

FIG. 20 is a perspective view illustrating a fixing structure for a slider and a blade according to the embodiment;

FIG. 21 is a view of the front part of the reciprocating saw according to the embodiment viewed from the lower side;

FIG. 22 is a diagram for explaining a method of replacing a blade clamp according to the embodiment;

FIG. 23 is a diagram for explaining a method of replacing the blade clamp according to the embodiment;

FIG. 24 is a cross-sectional view for explaining a method of fixing a vise to a work material according to a second embodiment;

FIG. 25 is a cross-sectional view for explaining the method of fixing the vise to the work material according to the second embodiment;

FIG. 26 is a cross-sectional view for explaining the method of fixing the vise to the work material according to the second embodiment;

FIG. 27 is a cross-sectional view for explaining the method of fixing the vise to the work material according to the second embodiment; and

FIG. 28 is a view schematically illustrating a part of a vise according to a third embodiment.

### DETAILED DESCRIPTION

In one or more embodiments, a vise to be attached to a reciprocating saw may include: a chain including a pin and to be wound around a work material; a vise base to be brought into contact with the work material, the vise including an insertion space into which the pin is inserted and a recess provided in the insertion space and in which the pin is hooked; a tightening tool to be operated to pull the chain wound around the work material, the tightening tool being coupled to the chain; and an elastic member that prevents the pin hooked in the recess from dropping.

In the configuration explained above, after being hooked in the recess, the pin of the chain is prevented from dropping from the recess by the elastic member. Since the pin is prevented from dropping from the recess, the pin after being hooked in the recess is prevented from dropping from the vise base. Since the pin of the chain is prevented from dropping from the vise base, deterioration in workability at the time when the vise is fixed to the work material is suppressed.

In one or more embodiments, a pair of the recesses may be provided in the insertion space such that a left end portion and a right end portion of the pin are respectively hooked in the pair of recesses. The elastic member may include a pair of leaf springs attached to the vise base. A pair of the elastic members may be disposed in an insertion port of the insertion space. A distance between the pair of elastic members may be shorter than a length of the pin.

In the configuration explained above, when the pin of the chain is inserted into the insertion space to be hooked in the recess, the pin passes between the pair of elastic members disposed in the insertion port of the insertion space. Since the distance between the pair of elastic members is shorter than the length of the pin of the chain, when the pin passes between the pair of elastic members, the pair of elastic members is elastically deformed to be separated from each other. Therefore, the pin is smoothly inserted into the insertion space. After the pin is inserted into the insertion space and hooked in the recess, the pair of elastic members is restored to approach each other. Since the distance between the pair of elastic members is shorter than the length of the pin of the chain, the pin after being hooked in the recess is covered with the elastic members. Since the pin is covered with the elastic members, the pin after being hooked in the recess is prevented from dropping from the vise base. Since the pin of the chain is prevented from dropping from the vise base, deterioration in workability at the time when the vise is fixed to the work material is suppressed. When the pin is hooked in the recess, the pin only has to be moved forward and inserted into the insertion space.

In one or more embodiments, the vise base may include a left wall portion and a right wall portion facing the left wall portion. The insertion space may be provided between the left wall portion and the right wall portion. The elastic members may be supported by the left wall portion and the right wall portion.

In the configuration explained above, the insertion space is provided between the left wall portion 41L and the right wall portion 41R, and the elastic members 45 are supported by the left wall portion 41L and the right wall portion 41R. Therefore, the pair of elastic members 45 is disposed in the insertion port 41N of the insertion space 41M.

In one or more embodiments, each the elastic members may include: a first portion fixed to the vise base; a second portion disposed at a position closer to the chain than the first portion; and a folded portion connecting the first portion and the second portion. A distance between a pair of the second portions may be shorter than the length of the pin.

In the configuration explained above, since the second portion functions as a barb, the pin after being hooked in the recess is effectively prevented from dropping from the vise base.

In one or more embodiments, the second portion may be disposed so as to cover the recess.

In the configuration explained above, the pin after being hooked in the recess is effectively prevented from dropping from the vise base.

In one or more embodiments, the vise may further include: a support plate that supports the first portion from an outer side of the insertion space; and a screw that fixes the support plate and the first portion to the vise base.

In the configuration explained above, the first portion is stably fixed to the vise base.

In one or more embodiments, the tightening tool may include a rod coupled to a lever via a hinge portion, and a holding member coupled to a lower end portion of the rod and holding one end portion of the chain wound around the work material. The elastic member may include a coil spring that is disposed around the rod and generates an elastic force such that the pin hooked in the recess is pressed against an inner surface of the recess.

In the configuration explained above, since the chain is pulled by the coil spring such that the pin is pressed against the inner surface of the recess, the pin after being hooked in the recess is prevented from dropping from the vise base. Since the pin of the chain is prevented from dropping from the vise base, deterioration in workability at the time when the vise is fixed to the work material is suppressed. After the pin is hooked in the recess, since the chain is pulled by the coil spring to tighten the work material, the chain is prevented from loosening.

In one or more embodiments, in a state in which the pin is hooked in the recess, the lever may be turned such that the work material is tightened by the chain.

In the configuration explained above, since the chain is fixed to the work material by the elastic force of the coil spring, the chain does not drop and the operator can easily tighten the work material with the chain 42 by slightly rotating the lever 43A. That is, an operation amount of the lever 43A by the operator is reduced.

In one or more embodiments, a reciprocating saw may include: a motor; a reciprocating motion conversion mechanism that is disposed forward of the motor and reciprocates a blade owing to a rotational force of the motor; and a vise attaching portion that is disposed forward of the motor and to which the vise according to claim 1 is attached.

In the configuration explained above, since deterioration in workability at the time when the vise is fixed to the work material is suppressed, deterioration in workability of work using the reciprocating saw is also suppressed.

In one or more embodiments, a reciprocating saw may include: a motor; a slider that is disposed forward of the motor and to which a blade is fixed; a reciprocating motion conversion mechanism that reciprocates the slider in a front-rear direction owing to a rotational force of the motor; a housing that houses the slider; and a shoe having a blade opening in which the blade is disposed, the shoe being attached to the housing to cover an opening provided in a front surface of the housing. The shoe may be configured to retract from the front surface of the housing in a state of being attached to the housing, so that the opening is exposed.

In the configuration explained above, the shoe retracts from the front surface of the front housing in a state of being attached to the front housing, so that the opening is exposed. Since the opening can be exposed even if the shoe is not completely separated from the front housing, the opening 4C is exposed with good workability.

In one or more embodiments, a reciprocating saw may include: a motor; a slider that is disposed forward of the motor and to which a blade is fixed; a reciprocating motion conversion mechanism that reciprocates the slider in a front-rear direction owing to a rotational force of the motor; a housing that houses the slider; and a shoe having a blade opening in which the blade is disposed, the shoe being attached to the housing to cover an opening provided in a front surface of the housing. The shoe may be turnably attached to the housing and is configured to retract from the front surface of the housing by turning.

In the configuration explained above, since the shoe retracts from the front surface of the front housing 4 by turning, the opening provided in the front surface of the front housing 4 is exposed with good workability.

In one or more embodiments, the shoe may move forward to be separated from the front surface of the housing and thereafter retracts from the front surface of the housing by turning.

In the configuration explained above, the shoe is smoothly turned after moving forward.

In one or more embodiments, the shoe may be turnably attached to the housing to change from a state of facing the front surface of the housing to a state of facing a side surface of the housing.

In the configuration explained above, the opening 4C is exposed with good workability.

In one or more embodiments, the shoe may include: a front plate portion facing the front surface of the housing and having the blade opening; and a lower plate portion facing a lower surface of the housing and having a long hole elongated in the front-rear direction. The shoe may include a screw coupled to, via the long hole, a screw hole provided in the lower surface of the housing. The shoe may be configured to move forward to be separated from a front end portion of the housing in a state in which the screw is inserted into the screw hole and thereafter turns, so that the front plate portion faces the side surface of the housing.

In the configuration explained above, when the shoe moves forward, the shoe is guided by the screw. When the shoe turns, the shoe can turn centering on the screw.

In one or more embodiments, the long hole may be provided on one side from a center of the lower plate portion in a left-right direction. The shoe may turn to face one of left and right side surfaces of the housing, which positions on the one side.

In the configuration explained above, the shoe is smoothly turned after moving forward. In the left-right direction, the long hole 12D may be provided on the right side, which is the other side, from the center of the lower plate portion 12B, and the shoe 12 may turn to face the right side surface of the front housing 4, which positions on the other side.

Embodiments are explained below with reference to the drawings. In the embodiments, a positional relation among parts are explained using terms of left, right, front, rear, up, and down. These terms indicate relative positions or directions based on the center of a reciprocating saw 1. The reciprocating saw 1 includes a motor 8 as a power source.

In the embodiment, a direction parallel to the rotation axis AX of the motor 8 is referred to as axial direction as appropriate, a direction of turning around the rotation axis AX is referred to as circumferential direction or rotation direction as appropriate, and a radiation direction of the rotation axis AX is referred to as radial direction as appropriate.

In the embodiment, the rotation axis AX extends in the front-rear direction. The axial direction parallel to the rotation axis AX is the front-rear direction. In the radial direction, a position close to or a direction approaching the rotation axis AX is referred to as radial direction inner side as appropriate and a position far from or a direction away from the rotation axis AX is referred to as radial direction outer side as appropriate.

### First Embodiment

A first embodiment is explained.

### Reciprocating Saw

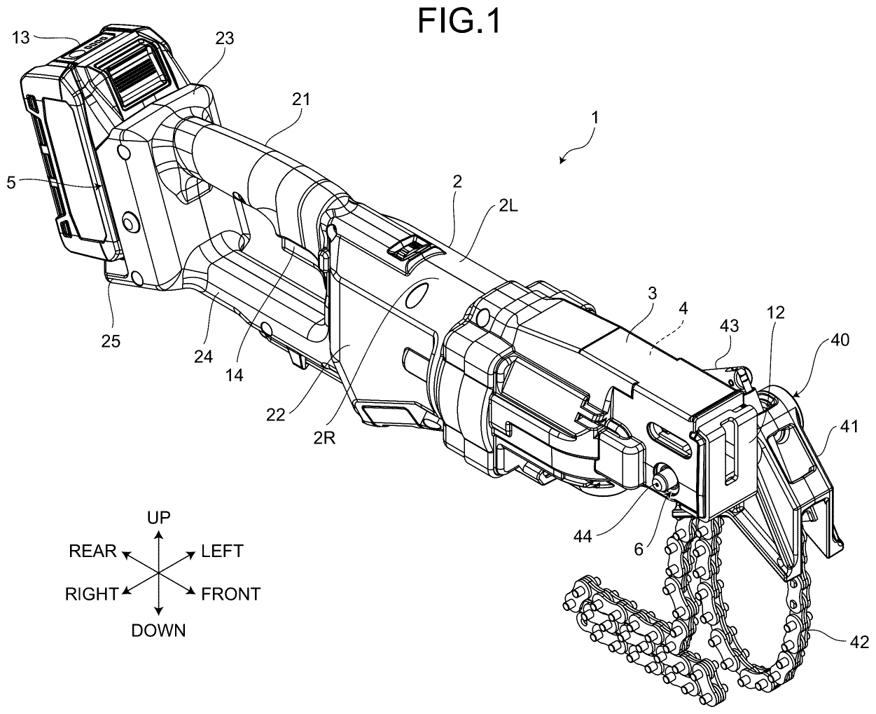

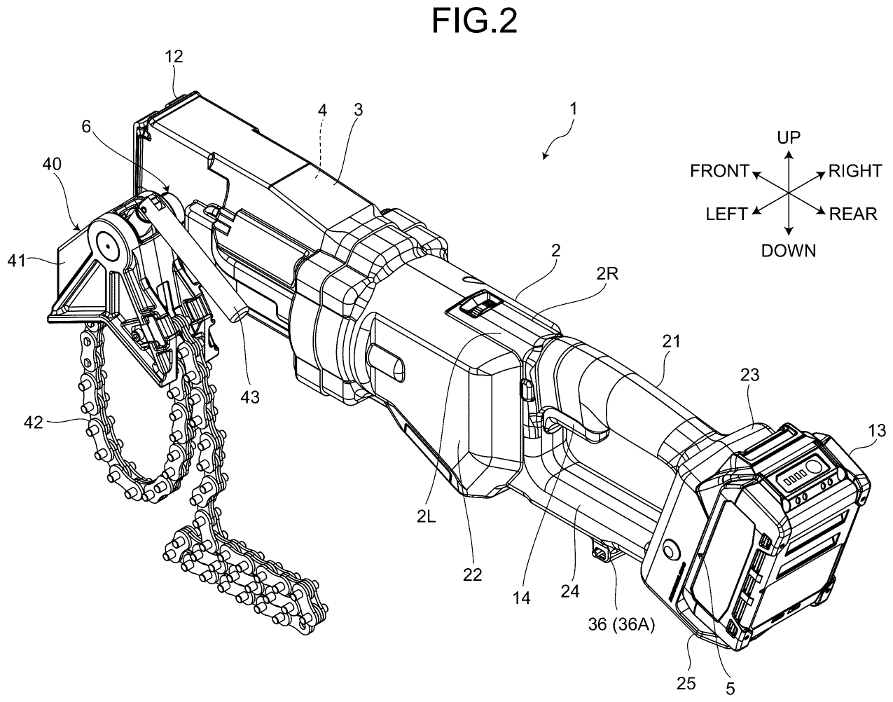

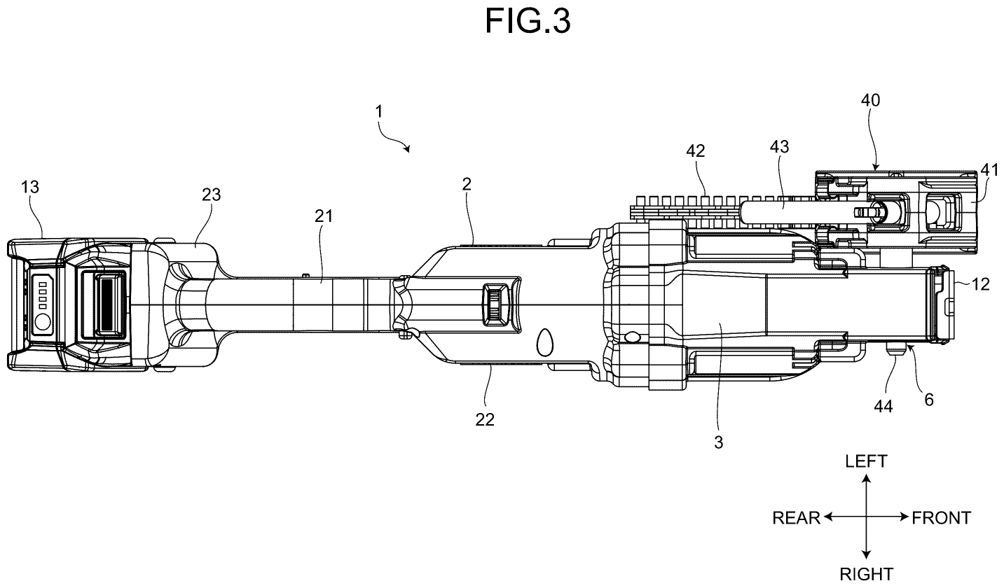

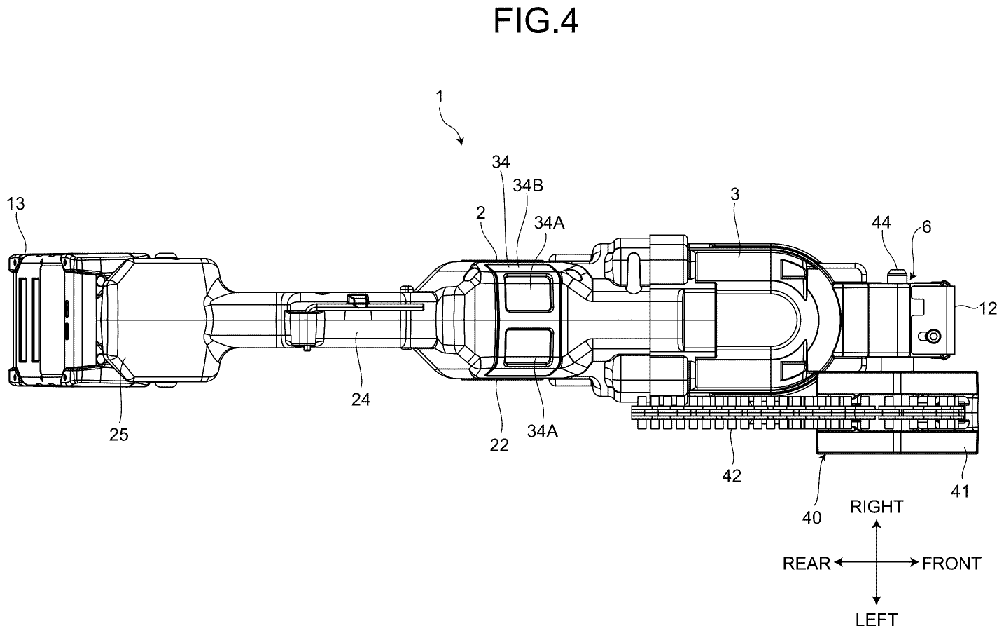

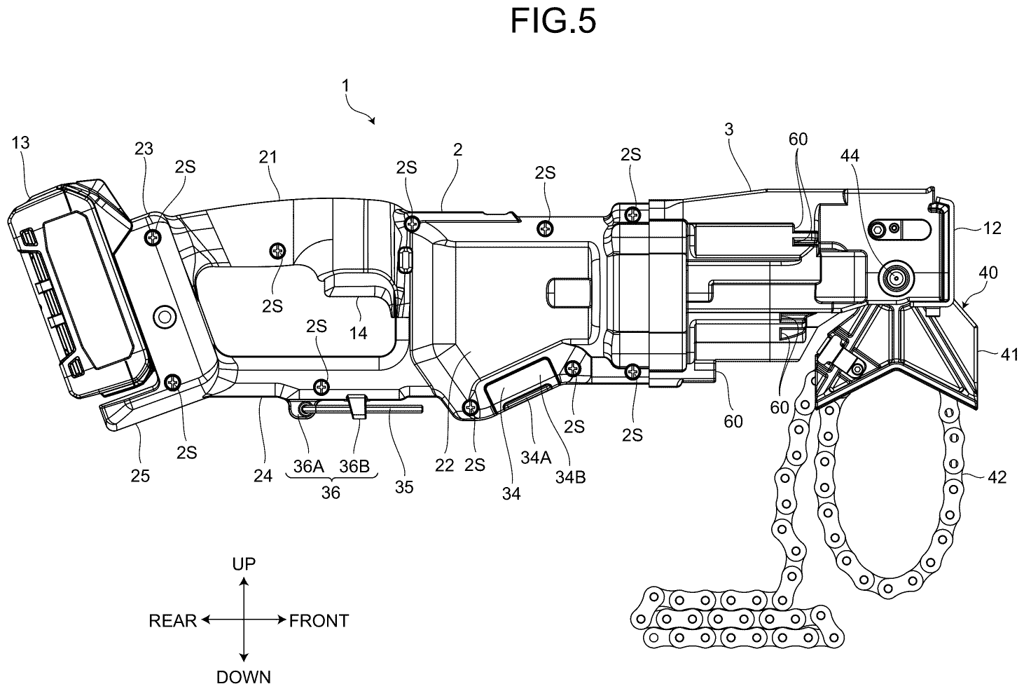

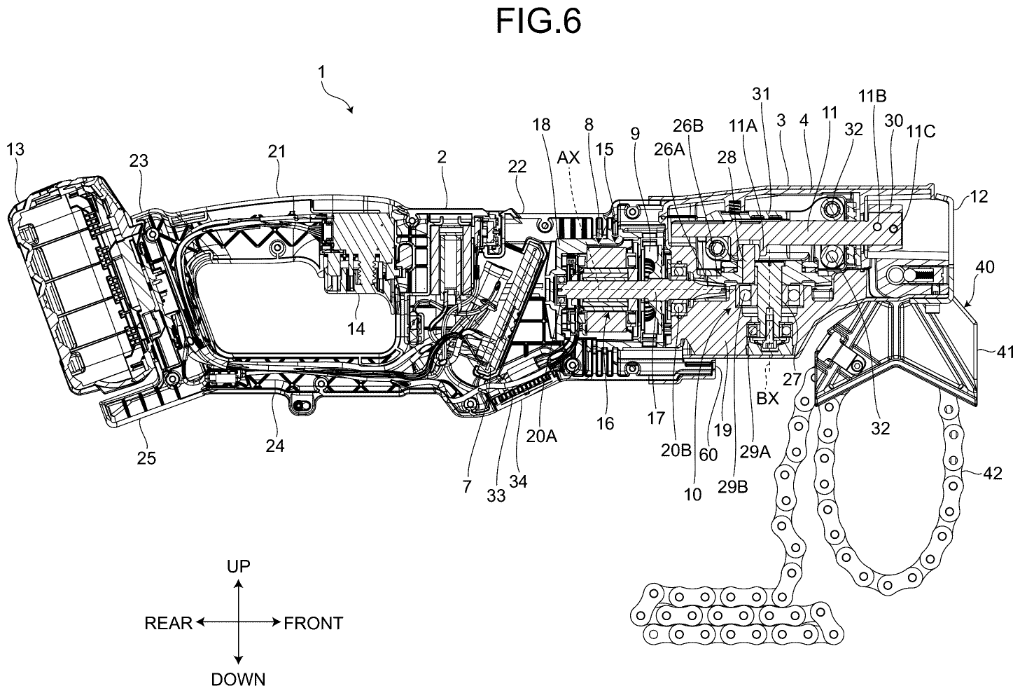

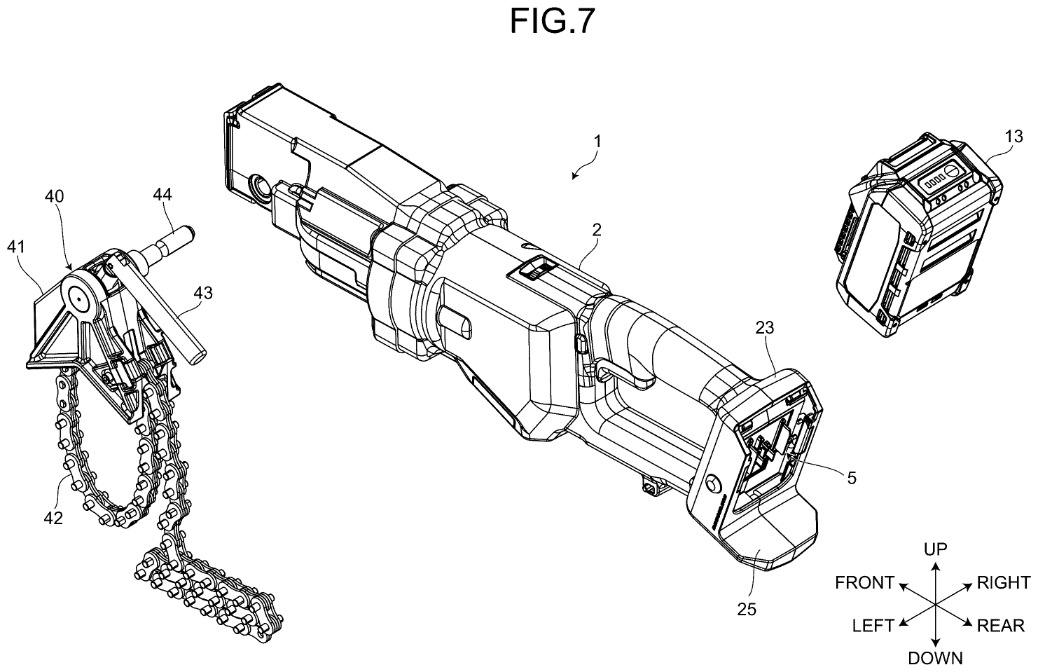

FIG. 1 is a front perspective view illustrating a reciprocating saw 1 according to a first embodiment. FIG. 2 is a perspective view from the rear side illustrating the reciprocating saw 1 according to the first embodiment. FIG. 3 is a view of the reciprocating saw 1 according to the first embodiment viewed from the upper side. FIG. 4 is a view of the reciprocating saw 1 according to the first embodiment viewed from the lower side. FIG. 5 is a view of the reciprocating saw 1 according to the first embodiment viewed from the right side. FIG. 6 is a cross-sectional view illustrating the reciprocating saw 1 according to the first embodiment. FIG. 7 is an exploded perspective view from the rear side illustrating the reciprocating saw 1 according to the first embodiment.

The reciprocating saw 1 includes a rear housing 2, a front housing 4, a battery attaching portion 5, a vise attaching portion 6, a controller 7, a motor 8, a fan 9, a reciprocating motion conversion mechanism 10, a slider 11, and a shoe 12.

The rear housing 2 is made of synthetic resin. The rear housing 2 includes a left housing 2L and a right housing 2R disposed on the right side of the left housing 2L. The left housing 2L and the right housing 2R constitute a pair of half-split housings. The rear housing 2 is constituted by the pair of half-split housings. The left housing 2L and the right housing 2R are fixed by a plurality of screws 2S.

The rear housing 2 includes a grip portion 21, a housing portion 22, a battery holding portion 23, a coupling portion 24, and a guard portion 25.

The grip portion 21 is gripped by an operator. The housing portion 22 houses the controller 7 and the motor 8. The housing portion 22 has a tubular shape. The motor 8 is disposed forward of the controller 7. The battery holding portion 23 holds a battery pack 13 via the battery attaching portion 5.

The coupling portion 24 is disposed downward of the grip portion 21. The coupling portion 24 is disposed to connect the housing portion 22 and the battery holding portion 23. The grip portion 21 is also disposed to connect the housing portion 22 and the battery holding portion 23. Each of the grip portion 21 and the coupling portion 24 has a rod shape elongated in the front-rear direction. The housing portion 22 is disposed on the front side of the grip portion 21 and the coupling portion 24. The battery holding portion 23 is disposed on the rear side of the grip portion 21 and the coupling portion 24. In the embodiment, the rear housing 2 includes a loop-shaped handle portion.

The guard portion 25 protrudes rearward from a lower part of the battery holding portion 23. The lower surface of the battery pack 13 attached to the battery attaching portion 5 and the upper surface of the guard portion 25 face each other with a gap therebetween. The operator can carry out work in a state in which the guard portion 25 is supported from below by a hand.

A trigger lever 14 is disposed on the grip portion 21. The trigger lever 14 is operated by the operator in order to start the motor 8. Driving and stopping of the motor 8 are switched by the trigger lever 14 being operated.

The front housing 4 is disposed on the front side of the rear housing 2. The front housing 4 has a tubular shape. The rear end portion of the front housing 4 is fixed to the front end portion of the rear housing 2. The front housing 4 includes a gear case 19. The front housing 4 houses the reciprocating motion conversion mechanism 10 and the slider 11. The front housing 4 is covered with a cover 3. The cover 3 is made of rubber and has an insulating property.

The battery attaching portion 5 is disposed in a rear part of the battery holding portion 23. The battery pack 13 is attached to the battery attaching portion 5. The battery pack 13 functions as a DC power supply of the reciprocating saw 1. The battery pack 13 is detachably attachable to the battery attaching portion 5. The battery pack 13 is attached to the battery attaching portion 5 by being inserted into the battery attaching portion 5 downward from the upper side of the battery attaching portion 5. The battery pack 13 is detached from the battery attaching portion 5 by being removed upward from the battery attaching portion 5.

The battery pack 13 includes a secondary battery. In embodiment, the battery pack 13 includes a rechargeable lithium-ion battery. By being attached to the battery attaching portion 5, the battery pack 13 can supply electric power to the reciprocating saw 1. The motor 8 is driven owing to the electric power supplied from the battery pack 13.

The controller 7 controls at least the motor 8. The controller 7 includes a circuit board and a plurality of electronic components mounted on the circuit board. Examples of the electronic components include a microcomputer and a switching element. The controller 7 is housed in the rear housing 2.

The motor 8 is a power source of the reciprocating saw 1. The motor 8 is an electric motor. The motor 8 is an inner rotor type brushless motor. The motor 8 includes a stator 15, a rotor 16, and a rotor shaft 17. The stator 15 is disposed around the rotor 16. The rotor shaft 17 is fixed to the rotor 16. The rotor 16 and the rotor shaft 17 rotate with respect to the stator 15. The rotor 16 and the rotor shaft 17 rotate about the rotation axis AX. The rotation axis AX extends in the front-rear direction.

The stator 15 includes a cylindrical stator core, an insulator fixed to the stator core, and a plurality of coils wound around teeth of the stator core via the insulator. The rotor 16 includes a cylindrical rotor core and a permanent magnet(s) fixed to the rotor core. The rotor shaft 17 is disposed on the inner side of the rotor core. The rotor shaft 17 is fixed to the rotor core. The rotor core and the rotor shaft 17 may be integral.

At least a part of the motor 8 is housed in a motor case 18. The motor case 18 is housed in the rear housing 2. The stator 15 is disposed on the inner side of the motor case 18. The stator 15 is fixed to the motor case 18. The gear case 19 of the front housing 4 is disposed on the front side of the motor case 18. The reciprocating motion conversion mechanism 10 is housed in the gear case 19.

The rear end portion of the rotor shaft 17 is rotatably supported by a bearing 20A. The front end portion of the rotor shaft 17 is rotatably supported by a bearing 20B. The bearing 20A is held by the motor case 18. The bearing 20B is held by the gear case 19.

The fan 9 is fixed to a front part of the rotor shaft 17. When the rotor shaft 17 rotates, the fan 9 rotates. When the fan 9 rotates, an air flow is generated around the motor 8. The motor 8 is cooled by the air flow generated by the rotation of the fan 9.

An intake port 33 is provided in a lower part of the housing portion 22. Exhaust ports 60 are provided in the cover 3. The air having passed around the motor 8 is discharged to the outside of the front housing 4 via the exhaust ports 60. In the embodiment, the intake port 33 is covered by a filter unit 34. The filter unit 34 includes a filter 34A and a filter holder 34B that holds the filter 34A. The filter holder 34B is attached to a lower part of the housing portion 22. Since the air around the rear housing 2 flows into the inside of the rear housing 2 via the intake port 33 in which the filter 34A is disposed, foreign matters around the rear housing 2 is prevented from entering the interior of the rear housing 2 via the intake port 33.

A pinion gear 26A is provided at the front end of the rotor shaft 17. The pinion gear 26A is disposed on the inner side of the gear case 19. The rotor shaft 17 is coupled to the reciprocating motion conversion mechanism 10 via the pinion gear 26A.

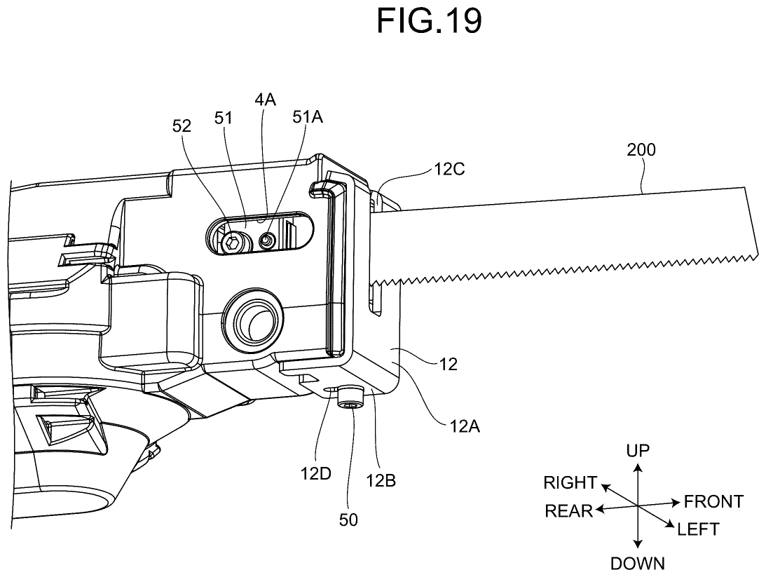

The reciprocating motion conversion mechanism 10 converts a rotational motion of the rotor shaft 17 into a reciprocating motion in the front-rear direction. The reciprocating motion conversion mechanism 10 is disposed forward of the motor 8. The reciprocating motion conversion mechanism 10 reciprocates the slider 11 in the front-rear direction owing to a rotational force of the motor 8. The slider 11 is disposed forward of the motor 8. A blade 200 (see FIG. 19), which is a type of a tip tool, is fixed to the slider 11. The slider 11 reciprocates in the front-rear direction, whereby the blade 200 reciprocates in the front-rear direction.

The reciprocating motion conversion mechanism 10 includes a bevel gear 26B to which the pinion gear 26A is coupled, a support shaft 27 to which the bevel gear 26B is fixed, and an eccentric pin 28 provided at an eccentric position of the bevel gear 26B. The support shaft 27 is rotatably supported by a bearing 29A and a bearing 29B. A slider block 11A is provided in the slider 11. At least a part of the eccentric pin 28 is disposed on the inner side of the slider block 11A. The bevel gear 26B rotates about a rotation axis BX orthogonal to the rotation axis AX. The bevel gear 26B rotates and the eccentric pin 28 turns around the rotation axis BX, whereby the eccentric pin 28 moves in the left-right direction on the inner side of the slider block 11A. The eccentric pin 28 moves in the left-right direction on the inner side of the slider block 11A while turning around the rotation axis BX, whereby the slider 11 is reciprocated in the front-rear direction.

The slider 11 reciprocates in the front-rear direction with the rotational force of the motor 8 transmitted via the reciprocating motion conversion mechanism 10. The slider 11 is guided in the front-rear direction by a slider guide 31 and a slider guide 32. The slider 11 has a screw hole 11B and an opening 11C for fixing the blade 200. The screw hole 11B and the opening 11C are provided at the front end portion of the slider 11. The opening 11C is provided on the front side of the screw hole 11B. The slider 11 functions as a tool tip holding portion to which the tip tool is attached.

The shoe 12 is disposed at the front end portion of the front housing 4. The shoe 12 is attached to the front housing 4.

### Vise

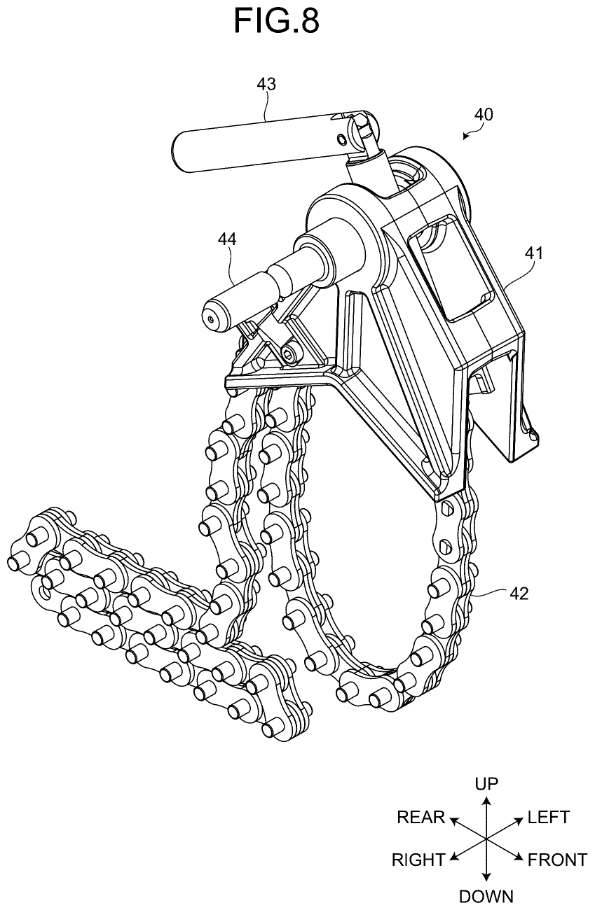

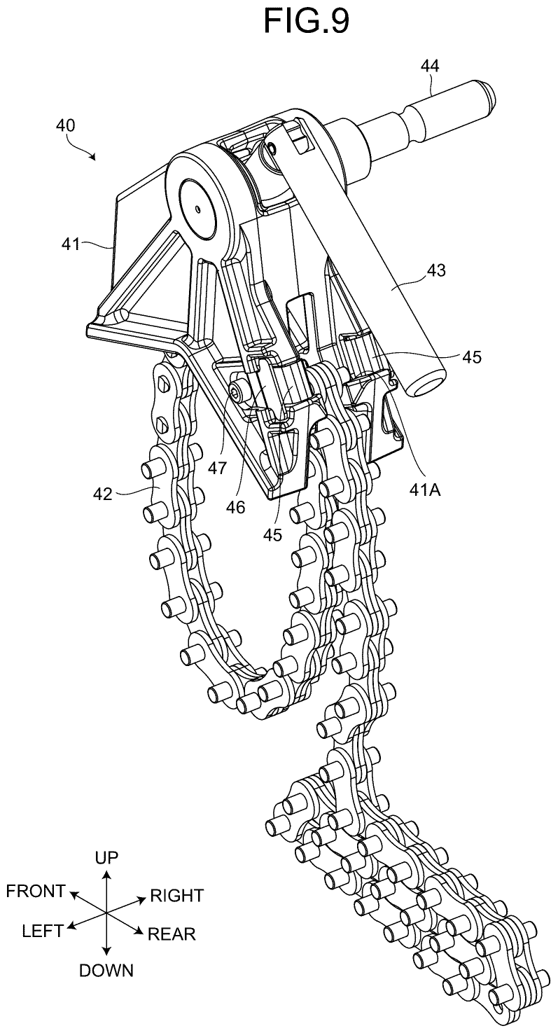

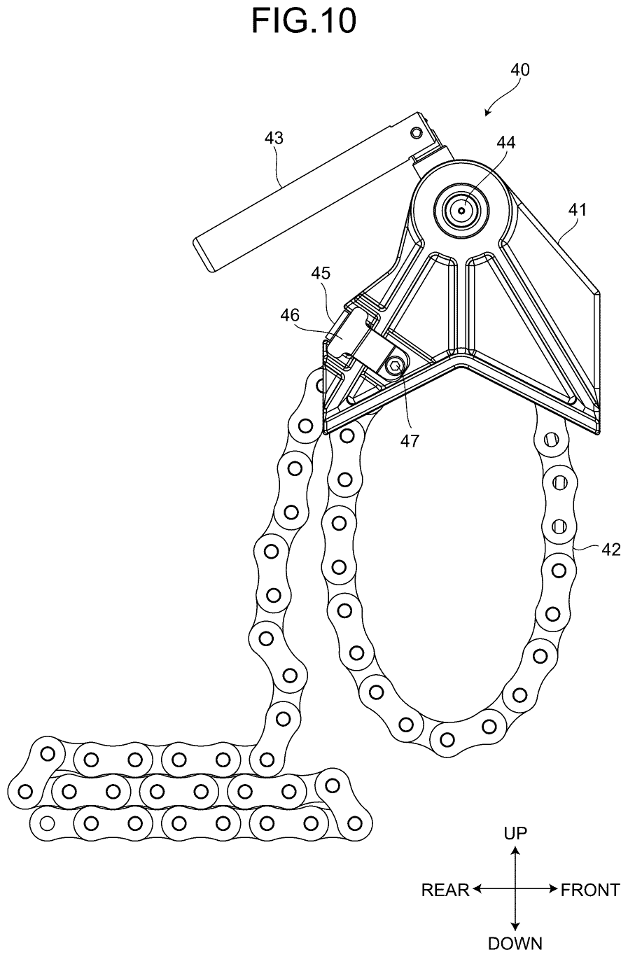

FIG. 8 is a perspective view from the front side illustrating a vise 40 according to the first embodiment. FIG. 9 is a perspective view from the rear side illustrating the vise 40 according to the first embodiment. FIG. 10 is a view of the vise 40 according to the first embodiment viewed from the right side.

The vise 40 is attached to the vise attaching portion 6. The vise 40 is fixed to a work material. In the embodiment, the vise 40 is a chain vise. The vise 40 includes a vise base 41 to be brought into contact with the work material, a chain 42 supported by the vise base 41 and wound around the work material, a tightening tool 43 that is coupled to the chain 42 and is to be operated to pull the chain 42 wound around the work material, an attachment rod 44 that is to be attached to the vise attaching portion 6, elastic members 45 attached to the vise base 41, support plates 46 that support the elastic members 45, and screws 47 that fix the elastic members 45 and the support plates 46 to the vise base 41.

The vise attaching portion 6 is disposed forward of the motor 8. The vise attaching portion 6 is disposed forward of the reciprocating motion conversion mechanism 10. The vise attaching portion 6 includes a hole provided at the front end portion of the front housing 4. The attachment rod 44 includes a bar-shaped member inserted into the hole of the vise attaching portion 6.

The vise 40 is detachably attachable to the vise attaching portion 6. In the embodiment, the vise base 41 is disposed on the left side of the front housing 4. The attachment rod 44 is inserted into the vise attaching portion 6 rightward from the left side of the vise attaching portion 6, whereby the vise 40 is attached to the vise attaching portion 6. The attachment rod 44 is removed leftward from the vise attaching portion 6, whereby the vise 40 is detached from the vise attaching portion 6.

Alternatively, the vise base 41 may be disposed on the right side of the front housing 4. The vise 40 may be attached to the vise attaching portion 6 by the attachment rod 44 being inserted into the vise attaching portion 6 leftward from the right side of the vise attaching portion 6. The vise 40 may be detached from the vise attaching portion 6 by the attachment rod 44 being removed rightward from the vise attaching portion 6.

The tightening tool 43 is operated in order to tighten the chain 42 wound around the work material to the work material. When cutting the work material such as a pipe, the operator brings the vise base 41 into contact with the work material and winds the chain 42 around the work material. After the chain 42 is wound around the work material, the operator operates the tightening tool 43 to tighten the chain 42 to the work material. Accordingly, the vise 40 is fixed to the work material.

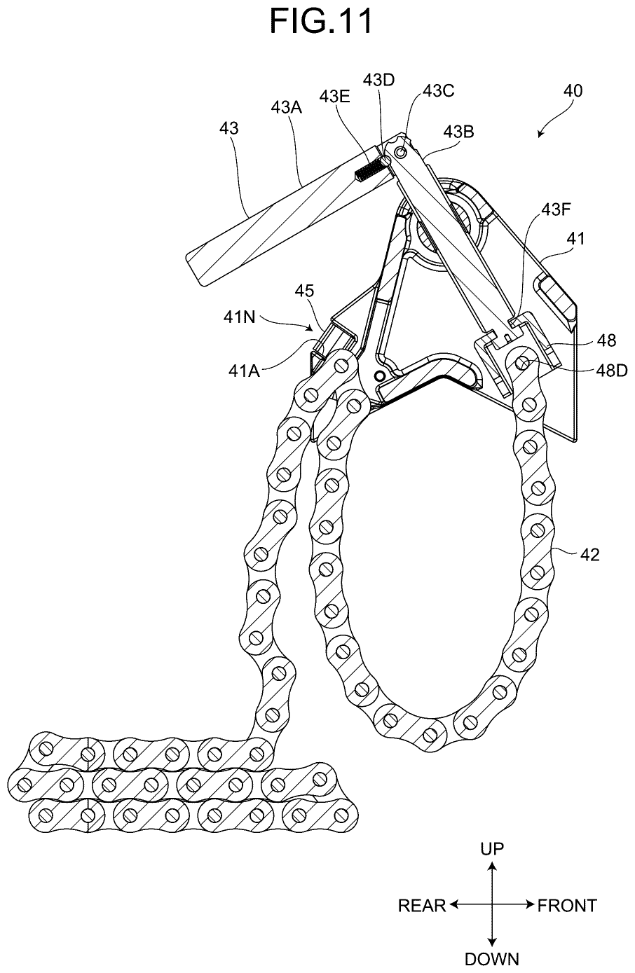

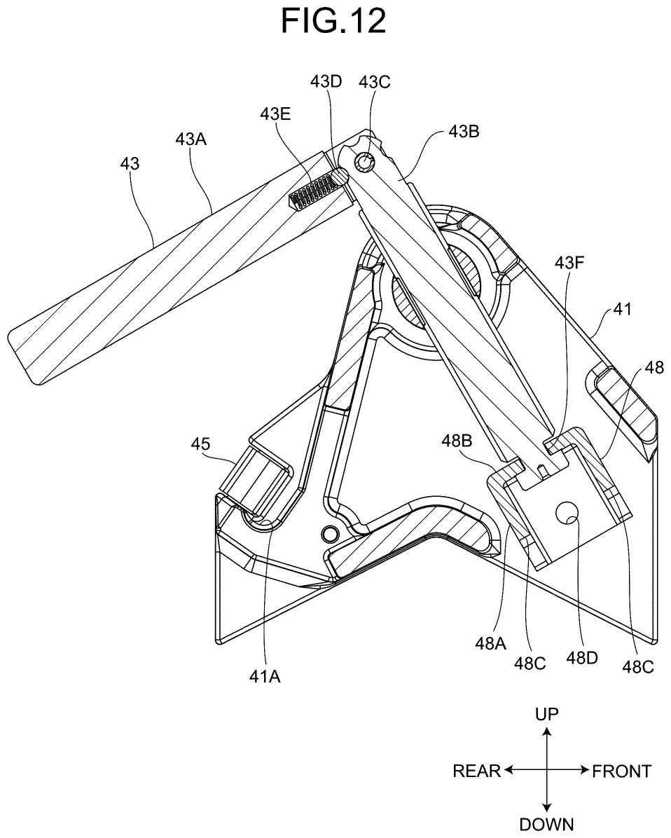

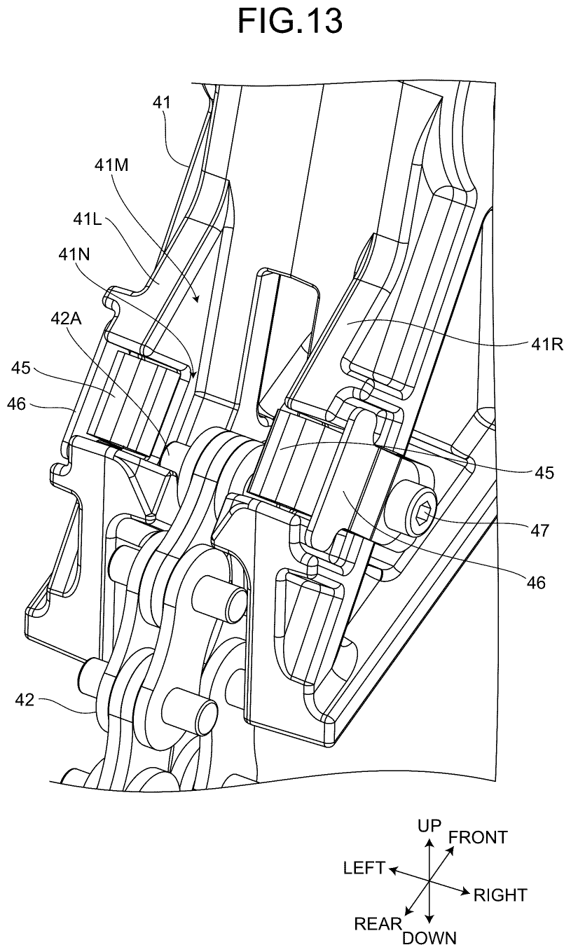

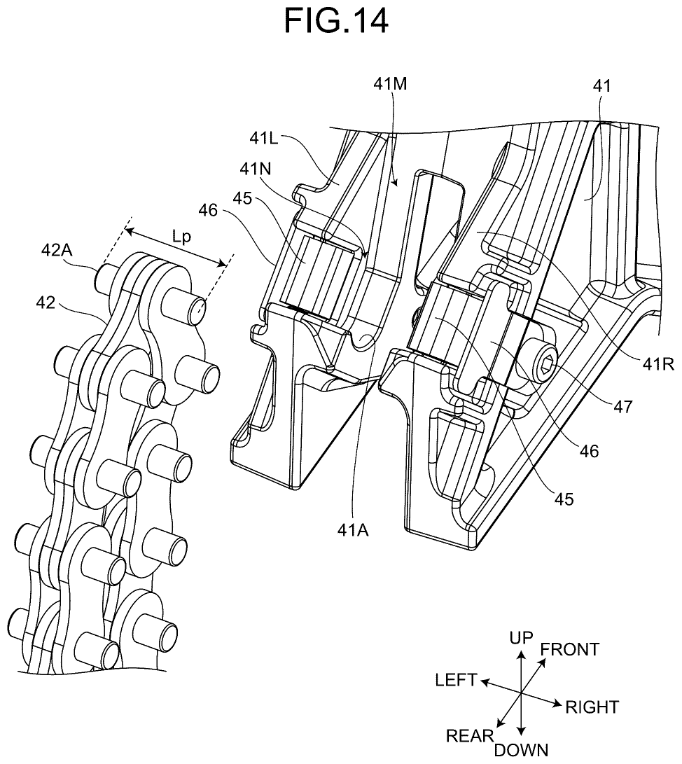

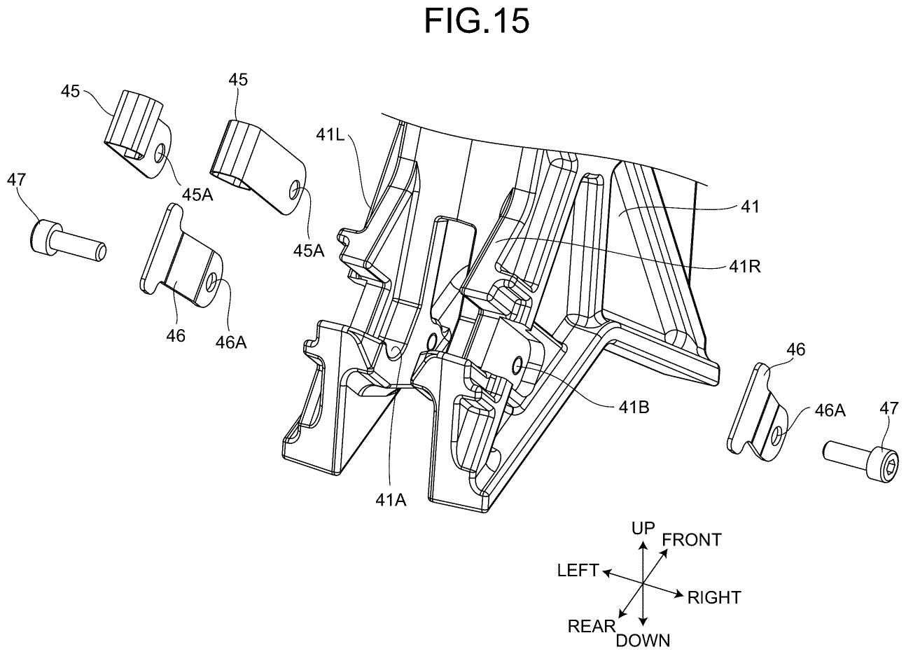

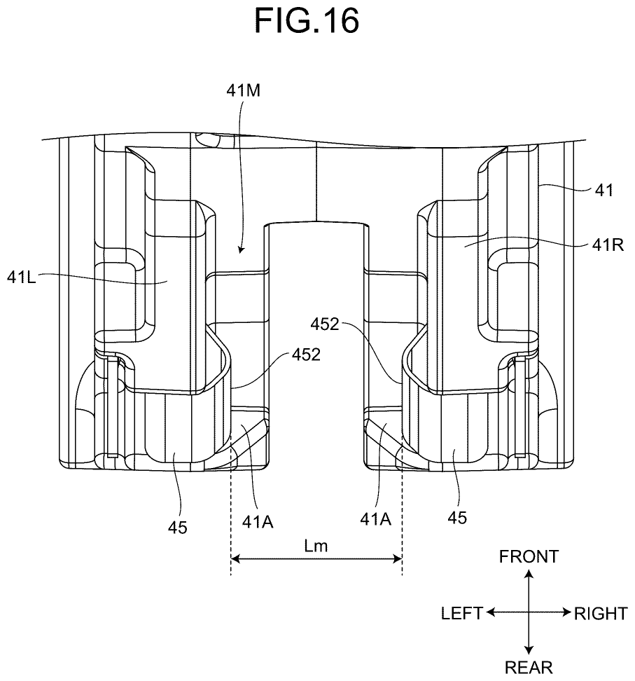

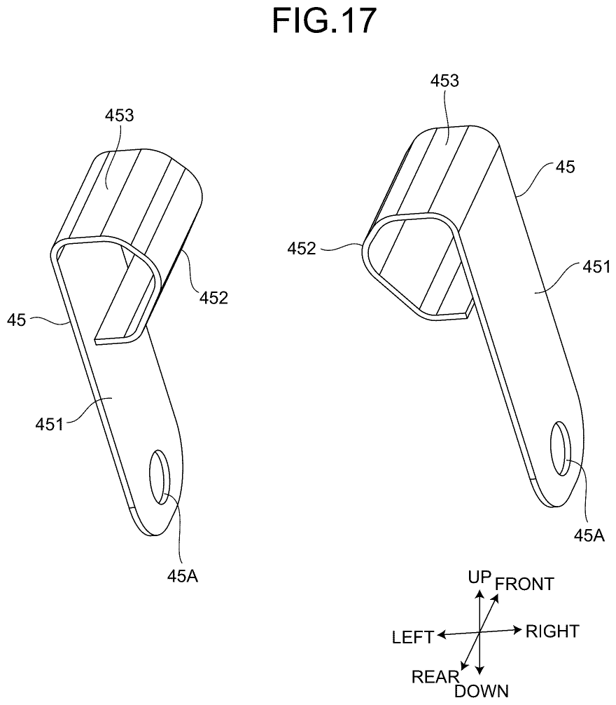

FIG. 11 is a cross-sectional view illustrating the vise 40 according to the first embodiment. FIG. 12 is a cross-sectional view illustrating a part of the vise 40 according to the first embodiment. FIG. 13 is a perspective view from the rear side illustrating a part of the vise 40 according to the first embodiment. FIG. 14 is a perspective view from the rear side illustrating a part of the chain 42 before being attached to the vise base 41 according to the first embodiment. FIG. 15 is an exploded perspective view from the rear side illustrating a part of the vise 40 according to the first embodiment. FIG. 16 is a view of a part of the vise 40 according to the first embodiment viewed from the upper side. FIG. 17 is a perspective view from the rear illustrating the elastic member 45 according to the first embodiment.

The tightening tool 43 includes a lever 43A, a rod 43B, a hinge portion 43C, a ball 43D, and a coil spring 43E. The lever 43A is connected to the rod 43B via the hinge portion 43C. The rod 43B is screwed to the attachment rod 44 and is rotatably supported by the vise base 41. The operator can turn the lever 43A. The lever 43A is turned, whereby the rod 43B rotates with respect to the attachment rod 44. The rod 43B rotates to thereby move in the axial direction with respect to the attachment rod 44. The ball 43D can fit in a recess provided on the surface of the rod 43B. The coil spring 43E is disposed on the inside of the lever 43A. The coil spring 43E generates an elastic force that presses the ball 43D against the rod 43B.

The vise 40 includes a holding member 48 that holds one end portion of the chain 42. The holding member 48 is disposed in an internal space of the vise base 41. The holding member 48 is coupled to the lower end portion of the rod 43B. A groove 43F is provided at the lower end portion of the rod 43B. A part of the holding member 48 is disposed on the inner side of the groove 43F, whereby the holding member 48 is coupled to the lower end portion of the rod 43B.

The holding member 48 includes a peripheral wall portion 48A, a hook portion 48B, a notch portion 48C, and a hole 48D. The peripheral wall portion 48A surrounds one end portion of the chain 42. The hook portion 48B is connected to the upper end portion of the peripheral wall portion 48A. The hook portion 48B is disposed on the inner side of the groove 43F. The notch portion 48C is cut upward from the lower end portion of the peripheral wall portion 48A. The chain 42 can enter the inner side of the notch portion 48C. Owing to the notch portion 48C, movement of the holding member 48 is not hindered. A pin at one end portion of the chain 42 is inserted into the hole 48D. The pin at one end portion of the chain 42 is inserted into the hole 48D, whereby one end portion of the chain 42 is held by the holding member 48.

The vise base 41 has an insertion space 41M into which a part of the chain 42 is inserted. The vise base 41 includes a left wall portion 41L and a right wall portion 41R facing the left wall portion 41L with a gap therebetween. The left wall portion 41L and the right wall portion 41R are provided at a rear part of the vise base 41. The right wall portion 41R is disposed on the right side of the left wall portion 41L. The insertion space 41M is provided between the left wall portion 41L and the right wall portion 41R.

When the chain 42 is wound around the work material, a pin 42A at the intermediate portion of the chain 42 is inserted into the insertion space 41M in a state in which one end portion of the chain 42 is held by the holding member 48. Recesses 41A in which the pin 42A is hooked are provided in the insertion space 41M. A pair of recesses 41A is provided. One recess 41A is provided at a lower part of the left wall portion 41L. The other recess 41A is provided at a lower part of the right wall portion 41R. The left end portion of the pin 42A inserted into the insertion space 41M is hooked in the recess 41A on the left side. The right end portion of the pin 42A inserted into the insertion space 41M is hooked in the recess 41A on the right side. The lever 43A is turned in a state in which the left end portion and the right end portion of the pin 42A are respectively hooked in the respective recesses 41A, whereby the chain 42 is pulled by the holding member 48 and the work material is tightened by the chain 42. The work material is tightened by the chain 42, whereby the vise 40 is fixed to the work material.

A pair of elastic members 45 is provided. The pair of elastic members 45 is attached to the vise base 41. The pair of elastic members 45 is disposed in an insertion port 41N of the insertion space 41M. The insertion port 41N of the insertion space 41M is provided at the upper end portion of the insertion space 41M. At least a part of the pair of elastic members 45 is disposed at the upper end portion of the insertion space 41M.

One elastic member 45 is supported by the left wall portion 41L. The other elastic member 45 is supported by the right wall portion 41R.

Each of the elastic members 45 is a leaf spring. As illustrated in FIG. 17, each of the elastic member 45 includes a first portion 451 elongated in the up-down direction, a second portion 452 shorter in length in the up-down direction than the first portion 451, and a folded portion 453 that connects the upper end portion of the first portion 451 and the upper end portion of the second portion 452.

The first portion 451 is fixed to the vise base 41. The second portion 452 is disposed at a position closer to the center of the insertion space 41M than the first portion 451. The second portion 452 is disposed at a position closer to the chain 42 than the first portion 451. In the elastic member 45 on the left side, the second portion 452 is disposed on the right side of the first portion 451. In the elastic member 45 on the right side, the second portion 452 is disposed on the left side of the first portion 451.

The center of the second portion 452 in the up-down direction protrudes toward the center of the insertion space 41M. The center of the second portion 452 protrudes toward the chain 42. The center of the second portion 452 of the elastic member 45 on the left side protrudes toward the right side. The center of the second portion 452 of the elastic member 45 on the right side protrudes toward the left side.

The support plates 46 support the respective first portions 451 from the outer side of the insertion space 41M. In the up-down direction, the length of the support plate 46 is smaller than the length of the first portion 451. The upper end of the support plate 46 is disposed downward of the folded portion 453.

The support plate 46 on the left side is disposed to be in contact the left surface of the first portion 451 of the elastic member 45 on the left side. The support plate 46 on the right side is disposed to be in contact the right surface of the first portion 451 of the elastic member 45 on the right side.

The screws 47 fix the support plates 46 and the first portions 451 to the vise base 41. An opening 46A is provided in a lower part of the support plate 46. An opening 45A is provided in a lower part of each of the first portions 451. The screws 47 are inserted into the openings 46A and the openings 45A and thereafter coupled to screw holes 41B provided in the vise base 41. The support plate 46 on the left side and the elastic member 45 on the left side are fixed to the left surface of the left wall portion 41L by the screw 47 on the left side. The support plate 46 on the right side and the elastic member 45 on the right side are fixed to the right surface of the right wall portion 41R by the screw 47 on the right side.

Each of the second portions 452 is disposed on the upper side of the recess 41A. The second portions 452 are disposed to cover the respective recesses 41A. The second portion 452 of the elastic member 45 on the left side is disposed to cover the recess 41A on the left side. The second portion 452 of the elastic member 45 on the right side is disposed to cover the recess 41A on the right side.

A distance Im between the pair of elastic members 45 is shorter than length Lp of the pin 42A hooked in the recesses 41A. As illustrated in FIG. 14, the length Lp of the pin 42A is a dimension of the pin 42A in the left-right direction. In the left-right direction, a distance Lm between the elastic member 45 on the left side and the elastic member 45 on the right side is shorter than the length Lp of the pin 42A.

As illustrated in FIG. 16, the distance Lm between the pair of elastic members 45 is the distance between the pair of second portions 452. The distance Lm between the pair of elastic members 45 is the distance between the second portion 452 of the elastic member 45 on the left side and the second portion 452 of the elastic member 45 on the right side. The distance Im between the pair of second portions 452 is shorter than the length Lp of the pin 42A hooked in the recesses 41A.

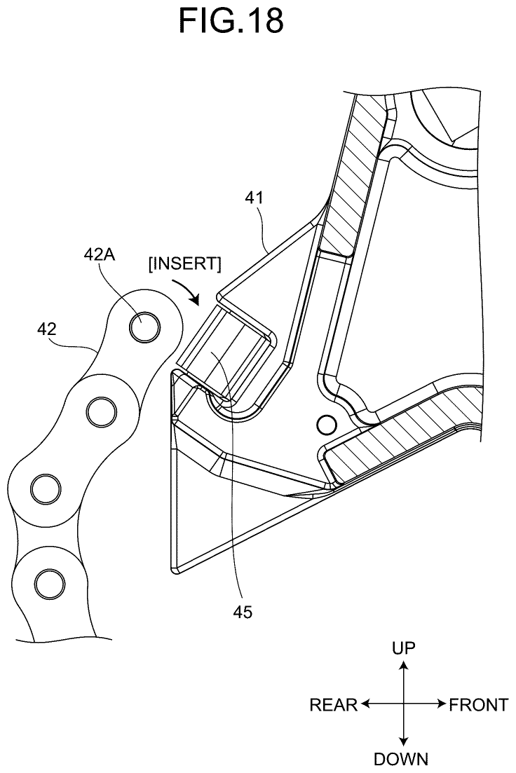

FIG. 18 is a view of a part of the chain 42 immediately before being inserted into the insertion space 41M according to the first embodiment viewed from the right side. The pin 42A at the intermediate portion of the chain 42 is inserted into the insertion space 41M from above the insertion space 41M.

When the pin 42A of the chain 42 is inserted into the insertion space 41M to be hooked in the recesses 41A, the pin 42A passes between the pair of second portions 452 disposed in the insertion port 41N of the insertion space 41M. Since the distance Im between the pair of second portions 452 is shorter than the length Lp of the pin 42A of the chain 42, when the pin 42A passes between the pair of second portions 452, the pair of elastic members 45 is elastically deformed such that the pair of second portions 452 is separated from each other. Since the pair of elastic members 45 is elastically deformed such that the pair of second portions 452 are separated from each other, the pin 42A is smoothly inserted into the insertion space 41M.

After the pin 42A is inserted into the insertion space 41M and hooked in the recesses 41A, the pair of elastic members 45 is restored such that the pair of second portions 452 approaches each other. Since the distance Lm between the second portions 452 of the pair of elastic members 45 is shorter than the length Lp of the pin 42A of the chain 42, the pin 42A after being hooked in the recesses 41A is covered with the second portions 452. Since the pin 42A is covered with the second portions 452, the pin 42A after being hooked in the recesses 41A is prevented from dropping from the vise base 41. That is, since the pin 42A is covered with the second portions 452, the pin 42A hooked in the recesses 41A is prevented from dropping. Since the pin 42A is covered with the second portions 452, even if the pin 42A is about to escape from the insertion space 41M, the pin 42A is caught by the second portions 452. Therefore, the pin 42A is prevented from escaping from the insertion space 41M. Since the pin 42A of the chain 42 is prevented from dropping from the vise base 41, deterioration in workability at the time when the vise 40 is fixed to the work material is prevented.

The second portions 452 function as a barb. Therefore, the pin 42A after being hooked in the recess 41A is effectively prevented from dropping from the vise base 41.

When the pin 42A is detached from the vise base 41, the pin 42A is pulled out from the insertion space 41M in a state in which the pair of elastic members 45 is elastically deformed such that the pair of second portions 452 is separated from each other. The operation of the lever 43A at the time when the pin 42A is detached from the vise base 41 is minimized. Similarly, an operation amount of the lever 43A at the time when the pin 42A is attached to the vise base 41 is also minimized.

### Shoe

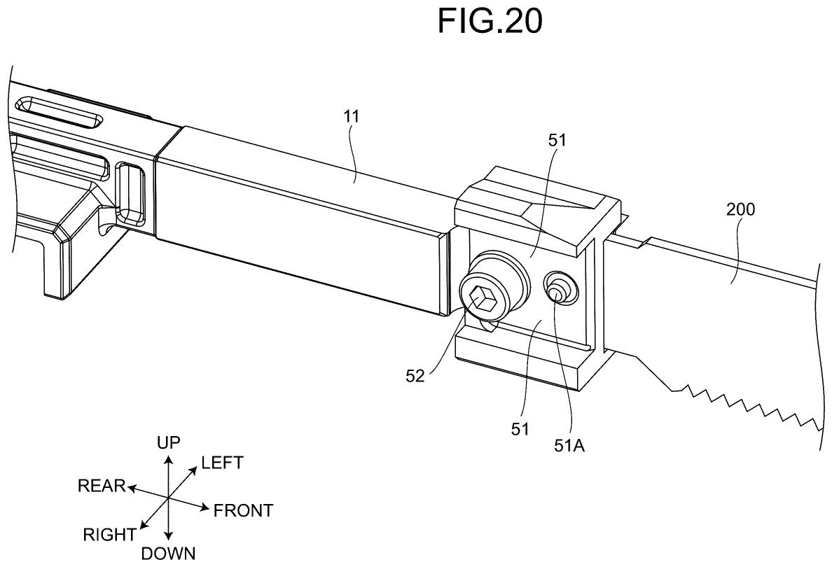

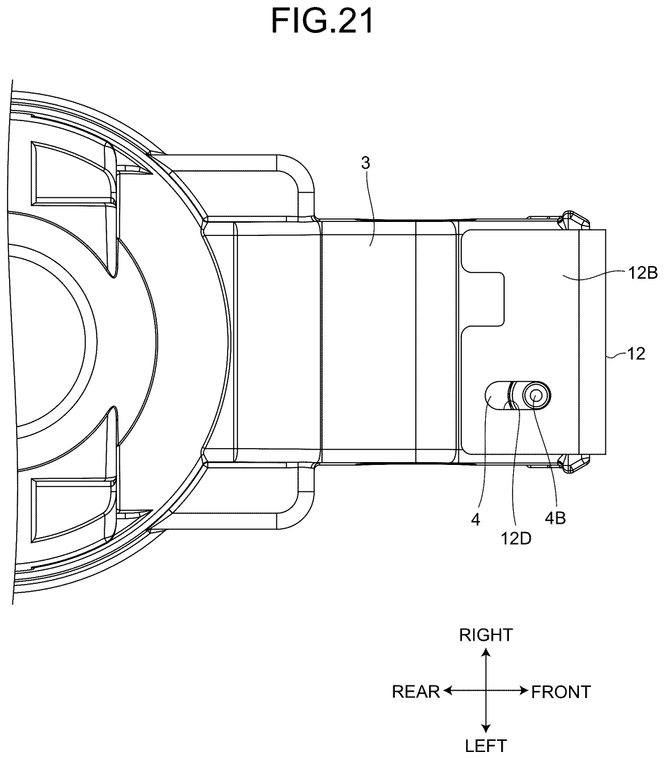

FIG. 19 is a perspective view illustrating a front part of the reciprocating saw 1 according to the first embodiment. FIG. 20 is a perspective view illustrating a fixing structure for the slider 11 and the blade 200 according to the first embodiment. FIG. 21 is a view of the front part of the reciprocating saw 1 according to the first embodiment viewed from the lower side.

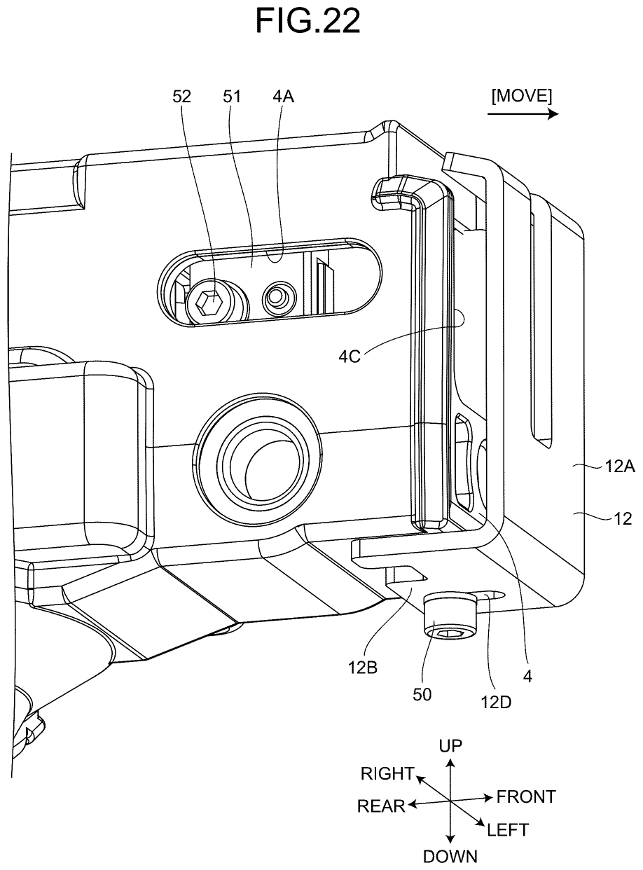

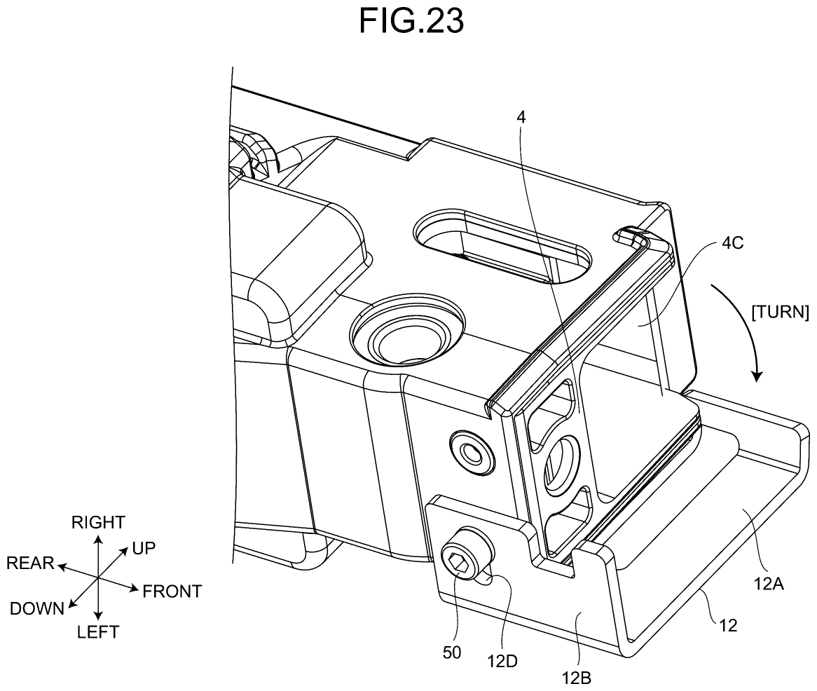

The shoe 12 is disposed at the front end of the front housing 4. The shoe 12 has a blade opening 12C in which the blade 200 is disposed. The shoe 12 is attached to the front housing 4 to cover an opening 4C (see FIG. 22 and FIG. 23) provided on the front surface of the front housing 4.

The shoe 12 includes a front plate portion 12A facing the front surface of the front housing 4 and a lower plate portion 12B facing the front part of the lower surface of the front housing 4. The blade opening 12C is provided in the front plate portion 12A.

The shoe 12 is fixed to the front housing 4 by a screw 50. The long hole 12D is provided in the lower plate portion 12B. The screw 50 is inserted into the long hole 12D. A screw hole 4B is formed in the lower surface of the front housing 4. The screw 50 is coupled to, via the long hole 12D, the screw hole 4B provided in the lower surface of the front housing 4. The shoe 12 is fixed to the front housing 4 by the screw 50 being coupled to the screw hole 4B via the long hole 12D in a state in which the front plate portion 12A is near or is contact with the front surface of the front housing 4.

The long hole 12D is elongated in the front-rear direction. As illustrated in FIG. 21, in the left-right direction, the long hole 12D is provided leftward of the center of the lower plate portion 12B.

When the shoe 12 is fixed to the front housing 4 by the screw 50 in a state in which the front plate portion 12A is near or is in contact with the front surface of the front housing 4, the screw 50 is disposed forward of the center of the long hole 12D in the long hole 12D. The screw 50 may be in contact with the front end portion of the inner surface of the long hole 12D.

As illustrated in FIG. 19 and FIG. 20, the slider 11 and the blade 200 are fixed via a blade clamp 51. The rear end portion of the blade 200 is sandwiched between the front end portion of the slider 11 and the blade clamp 51. The slider 11, the blade 200, and the blade clamp 51 are fixed by a screw 52. The screw 52 is inserted into the screw hole 11B (see FIG. 6) of the slider 11 via an opening provided in the blade clamp 51 and an opening provided at the rear end portion of the blade 200. The blade clamp 51 includes a pin portion 51A inserted into an opening 11C (see FIG. 6) of the slider 11.

An opening 4A is provided in a right part of the front part of the front housing 4. The head of the screw 52 is disposed on the right side of the blade clamp 51. The head of the screw 52 faces the opening 4A. The operator can rotate the screw 52 by inserting, via the opening 4A, a tool into a drive portion (a hole) provided at the head of the screw 52. That is, the operator can tighten or loosen the screw 52 by rotating the screw 52 via the opening 4A.

In the embodiment, the reciprocating saw 1 includes a tool holder 36 that holds a tool 35 for rotating the screw 50 and the screw 52. As illustrated in FIG. 5, the tool holder 36 is provided in a lower part of the coupling portion 24. The tool holder 36 includes a first holder portion 36A that holds a part of the tool 35 and a second holder portion 36B that holds another part of the tool 35. The second holder portion 36B is disposed forward of the first holder portion 36A.

### Method of Replacing Blade Clamp

Each of FIG. 22 and FIG. 23 is a diagram for explaining a method of replacing the blade clamp 51 according to the first embodiment. For example, when the blade clamp 51 is damaged, in order to replace the blade clamp 51, the operator loosens the screw 52 via the opening 4A to release the fixing of the blade clamp 51 by the screw 52. After the screw 52 is detached from the blade clamp 51, the blade clamp 51 is carried out to the outer side of the front housing 4 via the opening 4C provided in the front surface of the front housing 4.

In the embodiment, the shoe 12 can retract from the front surface of the front housing 4 in a state of being attached to the front housing 4, so that the opening 4C is exposed. The shoe 12 is turnably attached to the front housing 4. The shoe 12 can retract from the front surface of the front housing 4 by turning.

As illustrated in FIG. 22, when carrying out the blade clamp 51 to the outer side of the front housing 4, the operator loosens the screw 50. Although the screw 50 is loosened, the screw 50 is not detached from the screw hole 4B. Although the screw 50 is loosened, a state in which the screw 50 is inserted into the long hole 12D and the screw hole 4B is maintained.

The screw 50 is loosened, whereby the shoe 12 can be moved forward to be separated from the front surface of the front housing 4. The screw 50 is loosened, whereby the operator can move the shoe 12 forward such that the front plate portion 12A is separated from the front surface of the front housing 4. The shoe 12 is moved forward to be separated from the front surface of the front housing 4 in a state in which the screw 50 is inserted into the long hole 12D and the screw hole 4B. Since the screw 50 is disposed in the long hole 12D, the shoe 12 moves forward while being guided by the screw 50.

The shoe 12 moves forward, whereby the screw 50 is disposed rearward of the center of the long hole 12D in the long hole 12D. The screw 50 may be in contact with the rear end portion of the inner surface of the long hole 12D.

The shoe 12 is turnably attached to the front housing 4 by the screw 50 to change from a state of facing the front surface of the front housing 4 to a state of facing the left surface of the front housing 4. As illustrated in FIG. 23, the shoe 12 is moved forward to be separated from the front surface of the front housing 4 and thereafter turned to the left side centering on the screw 50. The shoe 12 is turned such that the front plate portion 12A faces the left surface of the front housing 4. The shoe 12 can retract from the front surface of the front housing 4 by being turned centering on the screw 50.

In the embodiment, the long hole 12D is provided leftward of the center of the lower plate portion 12B. For that reason, the operator can smoothly turn the shoe 12 such that the front plate portion 12A faces the left surface of the front housing 4.

The shoe 12 is turned centering on the screw 50 to change from a state in which the front plate portion 12A faces the front surface of the front housing 4 to a state in which the front plate portion 12A faces the side surface of the front housing 4. As illustrated in FIG. 23, the shoe 12 retracts from the front surface of the front housing 4, whereby the opening 4C of the front housing 4 is exposed. The operator can carry out the blade clamp 51 to the outer side of the front housing 4 via the opening 4C.

### Operation of Reciprocating Saw

After the vise 40 is fixed to the work material, the operator operates the trigger lever 14. When the trigger lever 14 is operated, the motor 8 is driven by electric power supplied from the battery pack 13. When the rotor 16 rotates about the rotation axis AX, the pinion gear 26A provided at the front end portion of the rotor shaft 17 rotates. When the pinion gear 26A rotates, the bevel gear 26B coupled to the pinion gear 26A rotates. When the bevel gear 26B rotates, the eccentric pin 28 eccentrically moves with respect to the rotation axis BX of the bevel gear 26B and the slider 11 reciprocates in the front-rear direction. When the slider 11 reciprocates in the front-rear direction, the blade 200 fixed to the slider 11 reciprocates in the front-rear direction. In a state in which the blade 200 is reciprocating in the front-rear direction, the operator grips the grip portion 21 and turns the reciprocating saw 1 centering on the attachment rod 44. The operator turns the reciprocating saw 1 centering on the attachment rod 44 in a state of gripping the grip portion 21 such that the grip portion 21 moves upward and the blade 200 moves downward. Accordingly, the reciprocating blade 200 is pushed into the work material and the work material is cut.

### Effects

As explained above, in the embodiment, the vise 40 includes: the chain 42 including the pin 42A and to be wound around the work material; the vise base 41 brought into contact with the work material and including the insertion space 41M into which the pin 42A is inserted and the recess 41A that is provided in the insertion space 41M and in which the pin 42A is hooked; the tightening tool 43 coupled to the chain 42 to be operated to pull the chain 42 wound around the work material, the tightening tool being coupled to the chain; and the elastic member 45 that prevents the pin 42A hooked in the recess 41A from dropping.

In the configuration explained above, after being hooked in the recess 41A, the pin 42A of the chain 42 is prevented from dropping from the recess 41A by the elastic member 45. Since the pin 42A is prevented from dropping from the recess 41A, the pin 42A after being hooked in the recess 41A is prevented from dropping from the vise base 41. Since the pin 42A of the chain 42 is prevented from dropping from the vise base 41, deterioration in workability at the time when the vise 40 is fixed to the work material is suppressed.

In one or more embodiments, a pair of recesses 41A is provided in the insertion space 41M such that the left end portion and the right end portion of the pin 42A are respectively hooked in the pair of recesses 41A. The elastic member 45 includes a pair of leaf springs attached to the vise base 41. A pair of elastic members is disposed in the insertion port 41N of the insertion space 41M. The distance Lm between the pair of elastic members 45 is shorter than the length Lp of the pin 42A.

In the configuration explained above, when the pin 42A of the chain 42 is inserted into the insertion space 41M to be hooked in the recess 41A, the pin 42A passes between the pair of elastic members 45 disposed in the insertion port 41N of the insertion space 41M. Since the distance Im between the pair of elastic members 45 is shorter than the length Lp of the pin 42A of the chain 42, when the pin 42A passes between the pair of elastic members 45, the pair of elastic members 45 is elastically deformed to be separated from each other. Therefore, the pin 42A is smoothly inserted into the insertion space 41M. After the pin 42A is inserted into the insertion space 41M and hooked in the recess 41A, the pair of elastic members 45 is restored to approach each other. Since the distance Lm between the pair of elastic members 45 is shorter than the length Lp of the pin 42A of the chain 42, the pin 42A after being hooked in the recess 41A is covered with the elastic members 45. Since the pin 42A is covered with the elastic members 45, the pin 42A after being hooked in the recess 41A is prevented from dropping from the vise base 41. Since the pin 42A of the chain 42 is prevented from dropping from the vise base 41, deterioration in workability at the time when the vise 40 is fixed to the work material is suppressed. When the pin 42A is hooked in the recess 41A, the pin 42A only has to be moved forward and inserted into the insertion space 41M.

In the embodiment, the vise base 41 includes the left wall portion 41L and the right wall portion 41R facing the left wall portion 41L. The insertion space 41M is provided between the left wall portion 41L and the right wall portion 41R. The elastic members 45 are supported by of the left wall portion 41L and the right wall portion 41R.

In the configuration explained above, the insertion space 41M is provided between the left wall portion 41L and the right wall portion 41R, and the elastic members 45 are supported by the left wall portion 41L and the right wall portion 41R. Therefore, the pair of elastic members 45 is disposed in the insertion port 41N of the insertion space 41M.

In the embodiment, each of the elastic members 45 includes the first portion 451 fixed to the vise base 41, the second portion 452 disposed at a position closer to the central of the insertion space 41M than the first portion 451, and the folded portion 453 connecting the first portion 451 and the second portion 452. The distance between the pair of second portions 452 is shorter than the length of the pin 42A.

In the configuration explained above, since the second portion 452 functions as a barb, the pin 42A after being hooked in the recess 41A is effectively prevented from dropping from the vise base 41.

In the embodiment, the second portion 452 is disposed to cover the recess 41A.

In the configuration explained above, the pin 42A after being hooked in the recess 41A is effectively prevented from dropping from the vise base 41.

In the embodiment, the vise 40 includes the support plate 46 that supports the first portion 451 from the outer side of the insertion space 41M and the screw 47 that fixes the support plate 46 and the first portion 451 to the vise base 41.

In the configuration explained above, the first portion 451 is stably fixed to the vise base 41.

In the embodiment, the reciprocating saw 1 includes: the motor 8; the reciprocating motion conversion mechanism 10 that is disposed forward of the motor 8 and reciprocates the blade 200 owing to a rotational force of the motor 8; and the vise attaching portion 6 that is disposed forward of the motor 8 and to which the vise 40 is attached.

In the configuration explained above, since deterioration in workability at the time when the vise 40 is fixed to the work material is suppressed, deterioration in workability of work using the reciprocating saw 1 is also suppressed.

As explained above, in the embodiment, the reciprocating saw 1 includes: the motor 8; the slider 11 that is disposed forward of the motor 8 and to which the blade 200 is fixed; the reciprocating motion conversion mechanism 10 that reciprocates the slider 11 in the front-rear direction owing to a rotational force of the motor 8; the front housing 4 that houses the slider 11; and the shoe 12 having the blade opening 12C in which the blade 200 is disposed, the shoe 12 being attached to the front housing 4 to cover the opening 4C provided on the front surface of the front housing 4. The shoe 12 retracts from the front surface of the front housing 4 in a state of being attached to the front housing 4, so that the opening 4C is exposed.

In the configuration explained above, the shoe 12 retracts from the front surface of the front housing 4 in a state of being attached to the front housing 4, so that the opening 4C is exposed. Since the opening 4C can be exposed even if the shoe 12 is not completely separated from the front housing 4, the opening 4C is exposed with good workability.

In the embodiment, the reciprocating saw 1 includes: the motor 8; the slider 11 that is disposed forward of the motor 8 and to which the blade 200 is fixed; the reciprocating motion conversion mechanism 10 that reciprocates the slider 11 in the front-rear direction owing to a rotational force of the motor 8; the front housing 4 that houses the slider 11; and the shoe 12 having the blade opening 12C in which the blade 200 is disposed, the shoe 12 being attached to the front housing 4 to cover the opening 4C provided on the front surface of the front housing 4. The shoe 12 is turnably attached to the front housing 4 and retracts from the front surface of the front housing 4 by turning.

In the configuration explained above, since the shoe 12 retracts from the front surface of the front housing 4 by turning, the opening 4C provided in the front surface of the front housing 4 is exposed with good workability.

In the embodiment, the shoe 12 moves forward to be separated from the front surface of the front housing 4 and thereafter retracts from the front surface of the front housing 4 by turning.

In the configuration explained above, the shoe 12 is smoothly turned after moving forward.

In the embodiment, the shoe 12 is turnably attached to the front housing 4 to change from a state of facing the front surface of the front housing 4 to a state of facing the side surface of the front housing 4.

In the configuration explained above, the opening 4C is exposed with good workability.

In the embodiment, the shoe 12 includes: the front plate portion 12A facing the front surface of the front housing 4 and having the blade opening 12C; and the lower plate portion 12B facing the lower surface of the front housing 4 and having the long hole 12D long in the front-rear direction. The shoe may include the screw 50 coupled to, via the long hole 12D, the screw hole 4B provided in the lower surface of the front housing 4. The shoe 12 moves forward to be separated from the front end portion of the front housing 4 in a state in which the screw 50 is inserted into the screw hole 4B and thereafter turns, so that the front plate portion 12A faces the side surface of the front housing 4.

In the configuration explained above, when the shoe 12 moves forward, the shoe 12 is guided by the screw 50. When the shoe 12 turns, the shoe 12 can turn centering on the screw 50.

In the embodiment, the long hole 12D is provided on the left side, which is one side, from the center of the lower plate portion 12B in the left-right direction. The shoe 12 turns to face the left surface of the front housing 4, which is positions on the left side.

In the configuration explained above, the shoe 12 is smoothly turned after moving forward. Note that, in the left-right direction, the long hole 12D may be provided further on the right side, which is the other side, than the center of the lower plate portion 12B. The shoe 12 may turn to face the right surface of the left and right side surfaces of the front housing 4.

### Second Embodiment

A second embodiment is explained. In the following explanation, components that are the same as or similar to the components in the embodiment explained above are denoted by the same reference numerals and signs and explanation of the components is simplified or omitted.

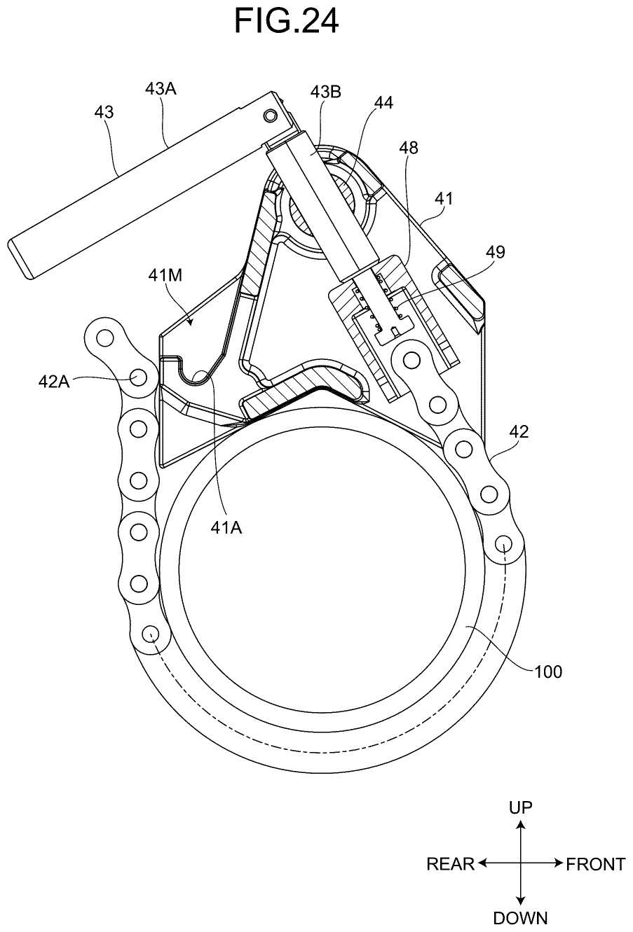

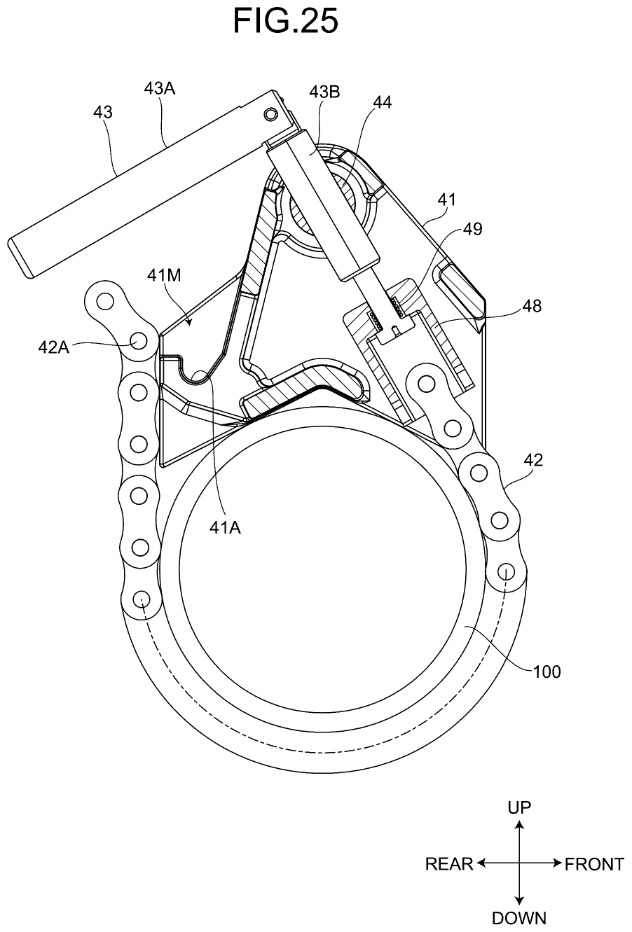

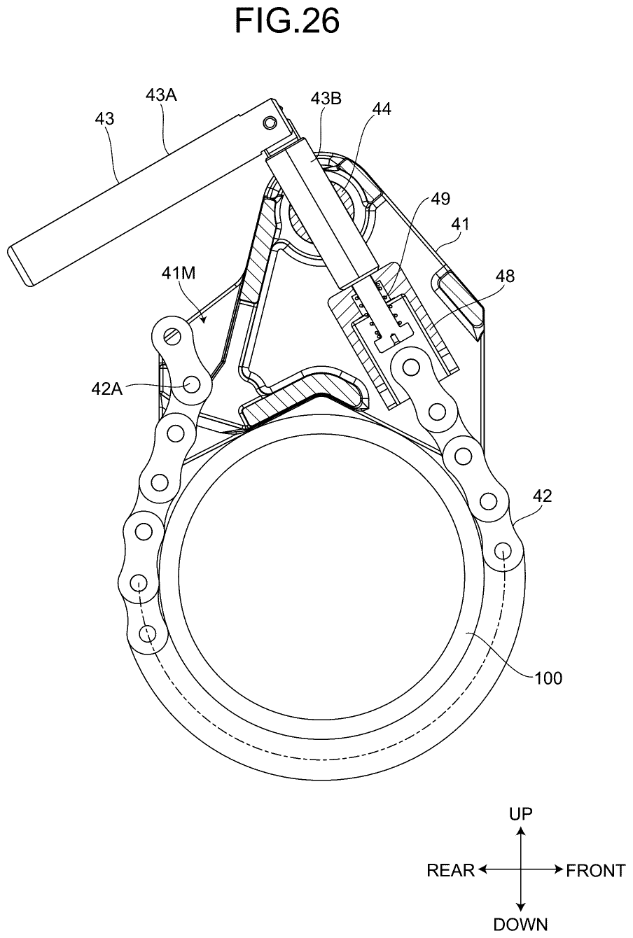

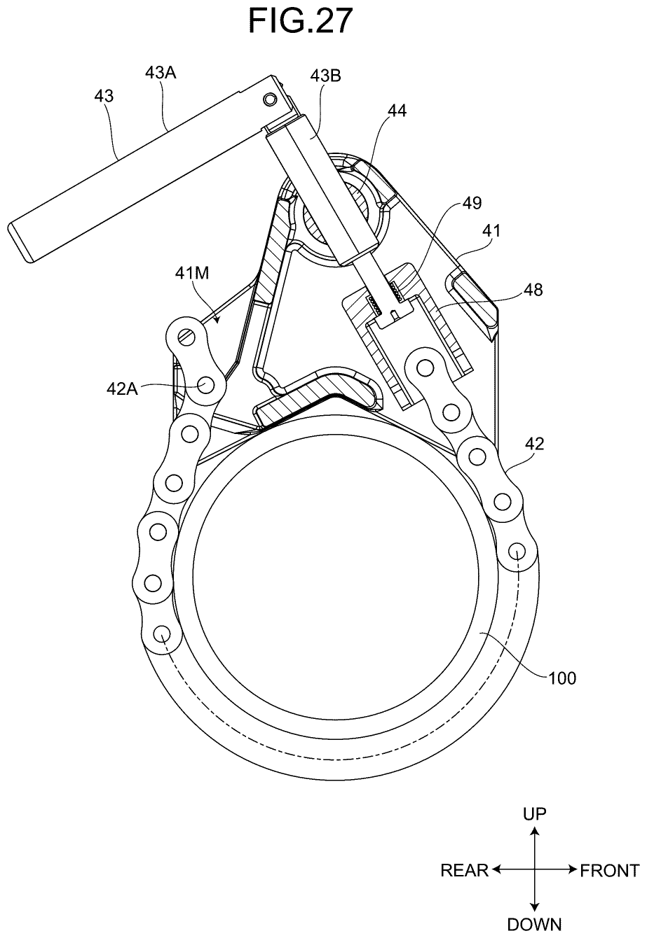

Each of FIG. 24, FIG. 25, FIG. 26, and FIG. 27 is a cross-sectional view for explaining a method of fixing the vise 40 according to the second embodiment to a work material 100. The work material is a pipe such as a steel pipe.

As illustrated in FIG. 24, one end portion of the chain 42 is held by the holding member 48. As illustrated in FIG. 24, a coil spring 49, which is an elastic member, is disposed around the rod 43B. When cutting the work material 100, an operator brings the vise base 41 into contact with a part of the work material 100 and winds the chain 42 around the work material 100. The operator applies the pin 42A to be hooked in the recess 41A to the rear surface of the vise base 41.

As illustrated in FIG. 25, the operator pulls the intermediate portion of the chain 42 upward by a hand and thereafter moves the pin 42A forward such that the pin 42A is inserted into the insertion space 41M. The intermediate portion of the chain 42 is pulled upward, whereby the holding member 48 moves downward. The holding member 48 moves downward, whereby the coil spring 49 contracts.

As illustrated in FIG. 26, the operator inserts the pin 42A into the insertion space 41M and hooks the pin 42A in the recesses 41A. The coil spring 49 generates an elastic force for pulling the chain 42. The pin 42A is hooked in the recesses 41A, whereby the intermediate portion of the chain 42 slightly moves downward. Therefore, the holding member 48 moves upward with a restoring force (an elastic force) of the coil spring 49. The pin 42A hooked in the recesses 41A is pressed against the inner surface of the recess 41A by the elastic force of the coil spring 49.

As illustrated in FIG. 27, after the pin 42A is hooked in the recesses 41A, the operator turns the lever 43A such that the work material 100 is tightened by the chain 42. The operator turns the lever 43A such that the holding member 48 moves upward. The lever 43A is turned, whereby the rod 43B rotates. A screw thread is formed on the outer circumferential surface of the rod 43B and a screw groove coupled to the screw thread of the rod 43B is provided in the attachment rod 44. The rod 43B rotates to thereby move upward. The rod 43B moves upward, whereby the holding member 48 moves upward. The holding member 48 moves upward and one end portion of the chain 42 is pulled upward, whereby the work material 100 is tightened by the chain 42. The work material is tightened with the chain 42, whereby the vise 40 is fixed to the work material 100.

As explained above, in the embodiment, the tightening tool 43 includes the rod 43B coupled to the lever 43A via a hinge portion, and the holding member 48 coupled to the lower end portion of the rod 43B and holding one end portion of the chain 42 wound around the work material. The coil spring 49 is disposed around the rod 43B. The coil spring 49 is disposed on the inner side of the holding member 48 and comes into contact with the holding member 48. The coil spring 49 generates an elastic force such that the pin 42A hooked in the recess 41A is pressed against the inner surface of the recesses 41A.

In the configuration explained above, since the chain 42 is pulled by the coil spring 49 such that the pin 42A is pressed against the inner surface of the recess 41A, the pin 42A after being hooked in the recess 41A is prevented from dropping from the vise base 41. Since the pin 42A of the chain 42 is prevented from dropping from the vise base 41, deterioration in workability at the time when the vise 40 is fixed to the work material is suppressed. After the pin 42A is hooked in the recess 41A, since the chain 42 is pulled by the coil spring 49 to tighten the work material, the chain 42 is prevented from loosening.

In the embodiment, in a state in which the pin 42A is hooked in the recess 41A, the lever 43A is turned such that the work material is tightened by the chain 42.

In the configuration explained above, since the chain 42 is fixed to the work material by the elastic force of the coil spring 49, the chain does not drop and the operator can easily tighten the work material with the chain 42 by slightly rotating the lever 43A. That is, an operation amount of the lever 43A by the operator is reduced.

### Third Embodiment

A third embodiment is explained. In the following explanation, components that are the same as or similar to the components in the embodiment explained above are denoted by the same reference numerals and signs and explanation of the components is simplified or omitted.

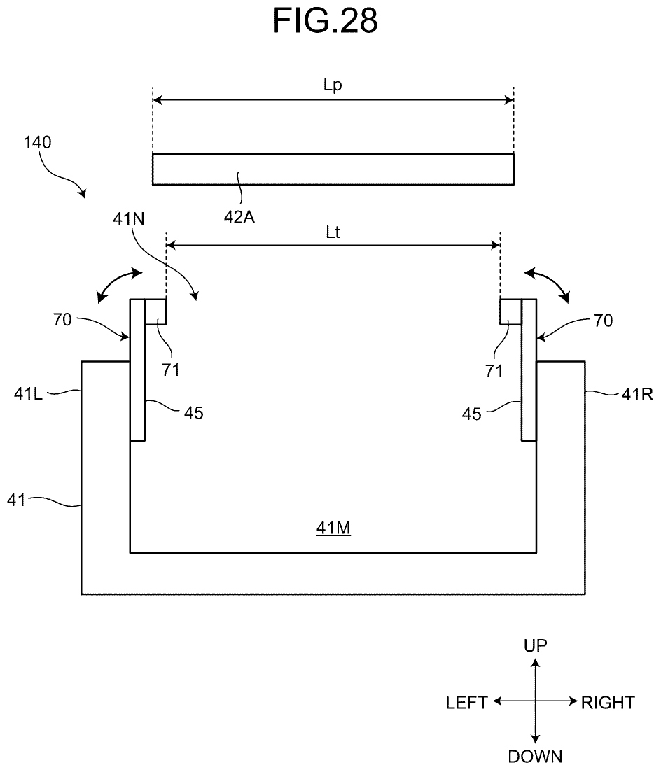

FIG. 28 is a diagram schematically illustrating a part of a vise 140 according to the third embodiment. In the embodiments explained above, the distance Im between the pair of elastic members 45 is the distance between the second portion 452 of the elastic member 45 on the left side and the second portion 452 of the elastic member 45 on the right side. As illustrated in FIG. 28, gate members 70 each including the elastic member 45 and a claw member 71 may be attached to the vise base 41. The claw member 71 is attached to the distal end portion of the elastic member 45. At least a part of the gate member 70 is elastically deformed. A pair of gate members 70 is disposed in the insertion port 41N of the insertion space 41M. A distance Lt between the pair of gate members 70 is shorter than the length Lp of the pin 42A. The distance Lt is the distance between the claw member 71 attached to the elastic member 45 on the left side and the claw member 71 attached to the elastic member 45 on the right side.

Additional aspects of the present teachings include, but are not limited to:
1. A reciprocating saw comprising:
a motor;
a slider that is disposed forward of the motor and to which a blade is fixed;
a reciprocating motion conversion mechanism that reciprocates the slider in a front-rear direction owing to a rotational force of the motor;
a housing that houses the slider; and
a shoe having a blade opening in which the blade is disposed, the shoe being attached to the housing to cover an opening provided in a front surface of the housing, wherein
the shoe is configured to retract from the front surface of the housing in a state of being attached to the housing, so that the opening is exposed.
2. The reciprocating saw according to the above aspect 1, wherein
the shoe moves forward to be separated from the front surface of the housing and thereafter retracts from the front surface of the housing by turning.
3. The reciprocating saw according to the above aspect 2, wherein
the shoe is turnably attached to the housing to change from a state of facing the front surface of the housing to a state of facing a side surface of the housing.
4. The reciprocating saw according to the above aspect 3, wherein
the shoe includes:
a front plate portion facing the front surface of the housing and having the blade opening; and
a lower plate portion facing a lower surface of the housing and having a long hole elongated in the front-rear direction, and
the shoe includes a screw coupled to, via the long hole, a screw hole provided in the lower surface of the housing, and
the shoe is configured to move forward to be separated from a front end portion of the housing in a state in which the screw is inserted into the screw hole and thereafter turns, so that the front plate portion faces the side surface of the housing.
5. The reciprocating saw according to the above aspect 4, wherein
the long hole is provided on one side from a center of the lower plate portion in a left-right direction, and
the shoe turns to face one of left and right side surfaces of the housing, which positions on the one side.
6. A reciprocating saw comprising:
a motor;
a slider that is disposed forward of the motor and to which a blade is fixed;
a reciprocating motion conversion mechanism that reciprocates the slider in a front-rear direction owing to a rotational force of the motor;
a housing that houses the slider; and
a shoe having a blade opening in which the blade is disposed, the shoe being attached to the housing to cover an opening provided in a front surface of the housing, wherein
the shoe is turnably attached to the housing and is configured to retract from the front surface of the housing by turning.
7. The reciprocating saw according to the above aspect 6, wherein
the shoe moves forward to be separated from the front surface of the housing and thereafter retracts from the front surface of the housing by turning.
8. The reciprocating saw according to the above aspect 7, wherein
the shoe is turnably attached to the housing to change from a state of facing the front surface of the housing to a state of facing a side surface of the housing.
9. The reciprocating saw according to the above aspect 8, wherein
the shoe includes:
a front plate portion facing the front surface of the housing and having the blade opening; and
a lower plate portion facing a lower surface of the housing and having a long hole elongated in the front-rear direction, and
the shoe includes a screw coupled to, via the long hole, a screw hole provided in the lower surface of the housing, and
the shoe is configured to move forward to be separated from a front end portion of the housing in a state in which the screw is inserted into the screw hole and thereafter turns, so that the front plate portion faces the side surface of the housing.
10. The reciprocating saw according to the above aspect 9, wherein
the long hole is provided on one side from a center of the lower plate portion in a left-right direction, and
the shoe turns to face one of left and right side surfaces of the housing, which positions on the one side.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vise to be attached to a reciprocating saw, the vise comprising:
a chain including a pin and to be wound around a work material;
a vise base to be brought into contact with the work material, the vise including an insertion space into which the pin is inserted and a recess provided in the insertion space and in which the pin is hooked;
a tightening tool to be operated to pull the chain wound around the work material, the tightening tool being coupled to the chain; and
an elastic member that prevents the pin hooked in the recess from dropping.

2. The vise according to claim 1, wherein
a pair of the recesses is provided in the insertion space such that a left end portion and a right end portion of the pin are respectively hooked in the pair of recesses,
the elastic member includes a pair of leaf springs attached to the vise base, and
a pair of the elastic members is disposed in an insertion port of the insertion space.

3. The vise according to claim 2, wherein
a distance between the pair of elastic members is shorter than a length of the pin.

4. The vise according to claim 2, wherein
the vise base includes a left wall portion and a right wall portion facing the left wall portion,
the insertion space is provided between the left wall portion and the right wall portion, and
the elastic members are supported by the left wall portion and the right wall portion.

5. The vise according to claim 3, wherein
each the elastic members includes:
a first portion fixed to the vise base;
a second portion disposed at a position closer to the chain than the first portion; and
a folded portion connecting the first portion and the second portion.

6. The vise according to claim 5, wherein
a distance between a pair of the second portions is shorter than the length of the pin.

7. The vise according to claim 5, wherein
the second portion is disposed so as to cover the recess.

8. The vise according to claim 5, further comprising:
a support plate that supports the first portion from an outer side of the insertion space; and
a screw that fixes the support plate and the first portion to the vise base.

9. The vise according to claim 1, wherein
the tightening tool includes
a rod coupled to a lever via a hinge portion, and
a holding member coupled to a lower end portion of the rod and holding one end portion of the chain wound around the work material, and
the elastic member includes a coil spring that is disposed around the rod and generates an elastic force such that the pin hooked in the recess is pressed against an inner surface of the recess.

10. The vise according to claim 9, wherein
in a state in which the pin is hooked in the recess, the lever is turned such that the work material is tightened by the chain.

11. A reciprocating saw comprising:
a motor;
a slider that is disposed forward of the motor and to which a blade is fixed;
a reciprocating motion conversion mechanism that reciprocates the slider owing to a rotational force of the motor; and
a vise attaching portion that is disposed forward of the motor and to which the vise according to claim 1 is attached.

12. The reciprocating saw according to claim 11, further comprising:
a housing that houses the slider; and
a shoe having a blade opening in which the blade is disposed, the shoe being attached to the housing to cover an opening provided in a front surface of the housing, wherein
the shoe is configured to retract from the front surface of the housing in a state of being attached to the housing, so that the opening is exposed.

13. The reciprocating saw according to claim 12, wherein
the shoe moves forward to be separated from the front surface of the housing and thereafter retracts from the front surface of the housing by turning.

14. The reciprocating saw according to claim 13, wherein
the shoe is turnably attached to the housing to change from a state of facing the front surface of the housing to a state of facing a side surface of the housing.

15. The reciprocating saw according to claim 11, further comprising:
a housing that houses the slider; and
a shoe having a blade opening in which the blade is disposed, the shoe being attached to the housing to cover an opening provided in a front surface of the housing, wherein
the shoe is configured to retract from the front surface of the housing in a state of being attached to the housing, so that the opening is exposed.

16. The reciprocating saw according to claim 15, wherein
the shoe moves forward to be separated from the front surface of the housing and thereafter retracts from the front surface of the housing by turning.

17. The reciprocating saw according to claim 16, wherein
the shoe is turnably attached to the housing to change from a state of facing the front surface of the housing to a state of facing a side surface of the housing.

18. A vise to be attached to a reciprocating saw, the vise comprising:
a vise base to be brought into contact with a work material;
a chain supported by the vise base and to be wound around the work material;
a tightening tool to be operated to pull the chain wound around the work material, the tightening tool being coupled to the chain; and
a pair of gate members attached to the vise base and at least partially elastically deformed, wherein
the vise base is provided in an insertion space into which a pin of the chain is inserted and includes a pair of recesses in which a left end portion and a right end portion of the pin are respectively hooked,
the pair of gate members is disposed in an insertion port of the insertion space, and
a distance between the pair of gate members is shorter than a length of the pin.

19. A reciprocating saw comprising:
a motor;
a reciprocating motion conversion mechanism that is disposed forward of the motor and reciprocates a blade owing to a rotational force of the motor; and
a vise attaching portion that is disposed forward of the motor and to which the vise according to claim 18 is attached.

20. The reciprocating saw according to claim 19, further comprising
a battery attaching portion to which a battery pack is attached.
